(19) United States
(12) Patent Application Publication
(10) Pub. No.: US 2025/0297337 A1
(43) Pub. Date: Sep. 25, 2025

(54) METHOD AND SYSTEM FOR REMOVING GANGUE COMPOUNDS FROM LITHIUM-CONTAINING MATERIALS

(71) Applicant: Board of Regents of Nevada System of Higher Education, on behalf of the University of Nevada, Reno, Reno, NV (US)

(72) Inventors: Pengbo Chu, Reno, NV (US); Sabinus Arthur, Reno, NV (US); Angela Tita, Reno, NV (US); Emmanuel Mends, Reno, NV (US)

(73) Assignee: Board of Regents of Nevada System of Higher Education, on behalf of the University of Nevada, Reno, Reno, NV (US)

(21) Appl. No.: 19/085,913

(22) Filed: Mar. 20, 2025

Related U.S. Application Data
(60) Provisional application No. 63/568,152, filed on Mar. 21, 2024.

(51) Int. Cl. C22B 26/20; B04B 3/00

(52) U.S. Cl. CPC C22B 26/20; B04B 3/00

(57) ABSTRACT

Disclosed herein are aspects of a method for removing one or more gangue compounds from lithium-containing material by producing and further treating a pre-treated feedstock obtained from the lithium-containing material. In certain aspects, the method can produce a calcium material-concentrated layer and a lithium-material concentrated layer and the ability to separate the two. Also, disclosed herein is a system for removing one or more gangue compounds from lithium-containing material, the system comprising a separating apparatus and a means for separating one or more gangue compounds from one or more lithium compounds. In aspects disclosed herein, separation can be based on a difference of a specific gravity of the one or more calcium compounds and a specific gravity of the one or more lithium compounds.

### CROSS REFERENCE TO RELATED APPLICATION

This application claims the benefit of and priority to the earlier filing date of U.S. Provisional Patent Application No. 63/568,152, filed on Mar. 21, 2024, the entirety of which is incorporated herein by reference.

### ACKNOWLEDGEMENT OF GOVERNMENT SUPPORT

This invention was made with government support under Contract No. DE-EE0009430, awarded by the U.S. Department of Energy. The government has certain rights in the invention.

### FIELD

The present disclosure concerns a method and system for removing one or more gangue compounds from lithium-containing materials.

### BACKGROUND

Climate change remains a global issue and solutions to this issue rely on clean energy production and consumption. Greenhouse gas emission by the transportation industry is one of the main contributors to climate change. Electric vehicles have the potential to reduce carbon emissions and mitigate the effects of climate change. Thus, there is a high demand for the raw materials used in producing the batteries used in electric vehicles such as manganese, lithium, cobalt, nickel, and graphite. However, sustainable, and effective methods for extracting these raw materials, particularly lithium, remains a challenge.

Lithium is primarily sourced by extraction from mineral ores and from brine deposits, which demands sophisticated processes for isolating and refining lithium to meet the high purity standards required in battery production. For example, acidification, which uses sulfuric acid and hydrochloric acid to leach lithium from calcium-containing materials requires high amounts of acids and also produces undesirable products that make downstream purification and separation process much more difficult dure to the presence of other ions in the pregnant leach solution (e.g., K⁺, Na⁺, Rb⁺, Cs⁺, Mn²⁺, Mg²⁺, and Al³⁺). Such methods also produce pure CO₂, resulting in a large carbon footprint, which goes against the purpose of using lithium to reduce greenhouse gas emission. Another challenge associated with obtaining lithium from calcium-rich clay stones arises from the complex nature of such clays, such as the very fine particle size of its constituent minerals, which is below the minimum particle size required for mineral processing techniques.

Accordingly, there is a need for new methods and compositions that can enrich calcium-containing materials while avoiding such drawbacks, therefore reducing energy requirements, reagent consumption, and production costs.

### SUMMARY

Disclosed herein is a method for removing one or more calcium compounds from a lithium-containing claystone, the method comprising: homogenizing a granulated material comprising the lithium-containing claystone; obtaining a pre-treated feedstock from the granulated material using a separating apparatus; feeding the pre-treated feedstock into a gravity concentrator; and centrifuging the pre-treated feedstock to form a calcium material-concentrated layer and a lithium material-concentrated layer.

Also disclosed is a system for removing one or more calcium compounds from a lithium-containing claystone, the system comprising: a separating apparatus; and a means for separating one or more calcium compounds from one or more lithium compounds present in the lithium-containing claystone, wherein the separating is based on a difference of a specific gravity of the one or more calcium compounds and a specific gravity of the one or more lithium compounds.

Also disclosed is a method for removing one or more calcium compounds from a lithium-containing claystone, the method comprising: feeding the lithium-containing claystone into the system of the present disclosure; and producing a calcium material-concentrated layer and a lithium material-concentrated layer.

The foregoing and other objects, features, and advantages of the present disclosure will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a schematic diagram illustrating at least certain steps of a method according to aspects of the present disclosure.

FIG. 1B is a schematic diagram illustrating at least certain steps of a method according to aspects of the present disclosure.

FIG. 2A is a scanning electron microscopy (SEM) image showing a first calcium-rich claystone exhibiting irregularly-shaped particles of different sizes.

FIG. 2B is an energy dispersive x-ray spectrum (EDS) showing the elemental analysis results of the first type of calcium-rich claystone (analyzed at the region noted with the arrow labeled “A” in FIG. 2A) comprising oxygen (49.9 wt. %) having a σ of 0.3; calcium (48.4 wt. %) having a σ of 0.2; strontium (1.0 wt. %) having a σ of 0.1; silicon (0.4 wt. %) having a σ of 0.1; and magnesium (0.4 wt. %) having a σ of 0.

FIG. 2C is an EDS showing the elemental analysis results of the first calcium-rich claystone (analyzed at the region noted with the arrow labeled “B” in FIG. 2A) comprising oxygen (41.4 wt. %) having a σ of 0.2; silicon (34.9 wt. %) having a σ of 0.2; magnesium (18.8 wt. %) having a σ of 0.1; fluorine (3.1 wt. %) having a σ of 0.1; calcium (1.3 wt. %) having a σ of 0.1; sodium (0.4 wt. %) having a σ of 0.1; and potassium (0.2 wt. %) having a σ of 0.1.

FIG. 3A is an SEM image showing a second type of calcium-rich claystone exhibiting irregularly-shaped particles of different sizes.

FIG. 3B is an EDS showing the elemental analysis results of the calcium-rich claystone (analyzed at the region noted with the arrow labeled “A” in FIG. 3A) comprising oxygen (40.0 wt. %) having a σ of 0.3; silicon (25.7 wt. %) having a σ of 0.2; calcium (15.3 wt. %) having a σ of 0.1; magnesium (10.1 wt. %) having a σ of 0.1; iron (7.1 wt. %) having a σ of 0.2; aluminum (1.3 wt. %) having a σ of 0.1; and titanium (0.5 wt. %) having a σ of 0.1.

FIG. 3C is an EDS showing the elemental analysis results of the calcium-rich claystone (analyzed at the region noted with the arrow labeled “B” in FIG. 3A) comprising oxygen (39.6 wt. %) having a σ of 0.3; silicon (25.7 wt. %) having a σ of 0.2; calcium (15.0 wt. %) having a σ of 0.1; magnesium (9.9 wt. %) having a σ of 0.1; iron (7.6 wt. %) having a σ of 0.2; aluminum (1.0 wt. %) having a σ of 0.1; titanium (0.5 wt. %) having a σ of 0.1; sodium (0.3 wt. %) having a σ of 0.1; and magnesium (0.3 wt. %) having a σ of 0.1.

FIG. 4A is an SEM image showing a magnesium-rich claystone comprising larger plate-type aggregates and cavities as compared to the calcium-rich claystones of FIG. 2A and FIG. 3A.

FIG. 4B is an EDS showing the elemental analysis results of the calcium-rich claystone (analyzed at the region noted with the arrow labeled “A” in FIG. 4A) comprising oxygen (48.0 wt. %) having a σ of 0.3; calcium (31.1 wt. %) having a σ of 0.2; magnesium (17.3 wt. %) having a σ of 0.1; iron (2.9 wt. %) having a σ of 0.1; strontium (0.4 wt. %) having a σ of 0.1; and magnesium (0.3 wt. %) having a σ of 0.1.

FIG. 4C is an EDS showing the elemental analysis results of the calcium-rich claystone (analyzed at the region noted with the arrow labeled “B” in FIG. 4A) comprising silicon (37.6 wt. %) having a σ of 0.2; oxygen (36.2 wt. %) having a σ of 0.2; magnesium (16.7 wt. %) having a σ of 0.1; fluorine (4.5 wt. %) having a σ of 0.2; Al (2.5 wt. %) having a σ of 0.1; iron (1.7 wt. %) having a σ of 0.2; potassium (0.5 wt. %) having a σ of 0.1; sodium (0.2 wt. %) having a σ of 0.1; and calcium (0.2 wt. %) having a σ of 0.1.

FIG. 4D shows the x-ray diffraction (XRD) results obtained from the first and second calcium-rich claystones shown in FIG. 2A and FIG. 3A, respectively, and of the magnesium-rich claystone of FIG. 4A;

FIG. 4D demonstrates strong calcite peaks at 20 for all three claystone samples.

FIG. 5A is a graph of the cumulative percent passing (%) as a function of screen size (microns) showing results obtained after sieving a first calcium-rich claystone (referred to herein as the “IN” claystone), a second calcium-rich claystone (referred to herein as the “AB” claystone), and a magnesium-rich claystone (referred to herein as the “LA” claystone).

FIG. 5B is a bar graph showing the elemental compositions for the IN claystone, the AB claystone, and the LA claystone, which compares the concentration (mg/kg) of Al, Ca, Fe, K, Li, Mg, and Na, of the IN, LA, and AB claystones.

FIG. 6A is a bar graph showing the lithium deportment (%) for the IN claystone, the AB claystone, and the LA claystone, which compares the lithium deportment in sieve sizes (μm) of +500, −500+300, −300+150, −150+75, −75+38, and −38 of the IN, LA, and AB claystones.

FIG. 6B is a bar graph showing the calcium deportment (%) for the IN claystone, the AB claystone, and the LA claystone, which compares the lithium deportment in sieve sizes (microns) of +500, −500+300, −300+150, −150+75, −75+38, and −38 of the IN, LA, and AB claystones.

FIG. 7A is a bar graph showing the fractions of lithium and calcium recovery (%) for the IN claystone, the AB claystone, and the LA claystone in the roughing heavies, cleaning lights, and cleaning heavies, which compares the lithium and calcium recovery (%) from the IN, LA, and AB claystones using aspects of the method and system disclosed herein.

FIG. 7B shows the XRD results obtained from the roughing heavies, cleaning lights, and cleaning heavies produced from centrifuging a pretreated feedstock obtained with no chemical dispersant from the AB claystone described for FIG. 3A; FIG. 7B demonstrates a lower calcite peak for the cleaning lights product stream.

FIG. 8A is a bar graph showing the fractions of lithium and calcium recovery (%) for the IN claystone, the AB claystone, and the LA claystone in the roughing heavies, cleaning lights, and cleaning heavies, which compares the lithium and calcium recovery (%) the IN, LA, and AB claystones using aspects of the method and system disclosed herein with a chemical dispersant.

FIG. 8B shows the XRD results obtained from the roughing heavies, cleaning lights, and cleaning heavies produced from centrifuging a pretreated feedstock obtained with a chemical dispersant from the AB claystone shown in FIG. 3A; FIG. 8B demonstrates a lower calcite peak at 20 for the cleaning lights product stream.

FIG. 8C shows the XRD results obtained from the roughing heavies, cleaning lights, and cleaning heavies produced from centrifuging a pretreated feedstock obtained with a chemical dispersant from the IN claystone shown in FIG. 2A; FIG. 8C demonstrates a lower calcite peak at 20 for the cleaning lights product stream.

FIG. 9A is a bar graph showing the particle size distribution after attrition of the AB claystone, which compares the percent oversize for (i) an “as-received” particle size distribution (PSD), (ii) Evaluation 1 (10 minutes, 150 rpm), (iii) Evaluation 2 (5 minutes, 50 rpm), (iv) Evaluation 3 (10 minutes, 100 rpm), and (v) Evaluation 4 (5 minutes, 100 rpm) at screen sizes (μm) of +500, −500+300, −300+150, −150+175, −75+38, and −38 using aspects of the method and system disclosed herein wherein attrition scrubbing was performed.

FIG. 9B is a bar graph showing the particle size distribution after attrition of the LA claystone, which compares the percent oversize for an (i) as-received PSD, Evaluation 1 (10 minutes, 100 rpm), Evaluation 2 (5 minutes, 150 rpm), and Evaluation 3 (3 minutes, 75 rpm) at screen sizes (μm) of +500, −500+300, −300+150, −150+175, −75+38, and −38 using aspects of the method and system disclosed herein wherein attrition scrubbing was performed.

FIG. 10A is a bar graph showing the fractions of lithium and calcium recovery (%) for the LA claystone in the roughing heavies, cleaning lights, and cleaning heavies, which compares the lithium and calcium recovery (%) using aspects of the method and system disclosed herein (i) with no chemical dispersant and (ii) with chemical dispersant.

FIG. 10B is a bar graph showing the fractions of lithium and calcium recovery (%) for the LA claystone in the roughing heavies, cleaning lights, and cleaning heavies, which compares the lithium and calcium recovery (%) using aspects of the method and system disclosed herein (i) with no chemical dispersant and (ii) with chemical dispersant.

FIG. 11A is a graph of the cumulative percent passing (%) as a function of screen size (microns) showing results obtained after sieving a calcium-rich claystone.

FIG. 11B is a bar graph showing the lithium deportment (%) for the calcium-rich claystone of FIG. 11A, which shows the distribution of lithium, calcium, magnesium, and iron in the sample at various particle size ranges.

FIG. 11C shows the XRD pattern obtained from analyzing the calcium-rich claystone of FIGS. 11A-11B, which pattern exhibits a prominent peak at 2 θ around 29°, demonstrating that calcite is the most prominent mineral.

FIG. 11D is a digital image showing the EDS spectrum of the calcium-rich claystone of FIGS. 11A-11C, which indicates percentages of elements present in the same (calcium at 30.6 wt. %, silicon at 17.6 wt. %, oxygen at 40.2 wt. %, and magnesium at 9.6 wt. %).

FIG. 12A is a graph showing the fractions of lithium and calcium recovery (%) for a calcium-rich claystone into the light stream for samples (i) without a pretreatment (Evaluation 1), (ii) with a pretreatment including chemical dispersion (Evaluation 2), (iii) with a pretreatment of attrition scrubbing (Evaluation 3), and (iv) with a pretreatment comprising attrition scrubbing and chemical dispersion (Evaluation 4).

FIG. 12B shows the XRD pattern obtained from analyzing the lights stream produced from centrifuging a pretreated feedstock obtained with chemical dispersant from the calcium-rich claystone shown in FIG. 12A.

FIG. 13A shows a Pareto Chart of the standardized effects of acid concentration (M), temperature (° C.), time (h), and S/L ratio (%) for lithium recovery from a lithium-containing claystone using a method according to the present disclosure.

FIG. 13B shows a Pareto Chart of the standardized effects of acid concentration (M), temperature (° C.), time (h), and S/L ratio (%) for calcium recovery from a lithium-containing claystone using a method according to the present disclosure.

FIG. 13C shows an individual effects plot of input parameters (acid concentration (M), temperature (° C.), time (h), and S/L ratio (%)) for lithium recovery from a lithium-containing claystone using a method according to the present disclosure.

FIG. 13D shows an individual effects plot of input parameters (acid concentration (M), temperature (° C.), time (h), and S/L ratio (%)) for calcium recovery from a lithium-containing claystone using a method according to the present disclosure.

FIG. 13E shows contour plots of lithium recovery demonstrating the combined interactions of acid concentration and leaching temperature (top left image); leaching temperature and time (top right image); acid concentration and time (middle left image); leaching temperature and solid-liquid ratio (middle right image); acid concentration and solid-liquid ratio (bottom left image); and time and solid-liquid ratio (bottom right image).

FIG. 13F shows contour plots of calcium recovery demonstrating the combined interactions of acid concentration and leaching temperature (top left image); acid concentration and solid-liquid ratio (top right image); acid concentration and time (middle left image); leaching temperature and time (middle right image); leaching temperature and solid-liquid ratio (bottom left image); and time and solid-liquid ratio (bottom right image).

FIG. 14A is a bar graph showing the contribution of input materials and energy in a method for extracting lithium for 1 gram of lithium leached using a gravity concentrator prior to leaching.

FIG. 14B is a bar graph showing the contribution of input materials and energy in a method for extracting lithium for 1 gram of lithium leached without using a gravity concentrator prior to leaching.

FIG. 14C is a bar graph showing comparison of global warming potential (GWP kg CO₂ eq) of lithium extraction without using a gravity concentrator prior to any leaching (according to aspects of the method disclosed herein) and using a gravity concentrator according to aspects of the method disclosed herein.

### DETAILED DESCRIPTION

### I. Overview of Terms, Ranges, and Definitions

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

The methods described herein should not be construed as limiting in any way. Instead, the present disclosure is directed toward all novel and non-obvious features and aspects of the present disclosure, alone and in various combinations and sub-combinations with one another. The disclosed methods are not limited to any specific aspect or feature or combinations thereof, nor do the disclosed methods require that any one or more specific advantages be present or problems be solved. Any theories of operation are to facilitate explanation, but the methods are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed devices and methods can be used in conjunction with other devices and methods. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. Furthermore, examples may be described with reference to directions indicated as “above,” “below,” “upper,” “lower,” and the like. These terms are used for convenient description, but do not imply any particular spatial orientation unless so indicated.

In some examples, values, procedures, or devices may be referred to as “lowest,” “best,” “minimum,” or the like. It will be appreciated that such descriptions are intended to indicate that a selection among many used functional alternatives can be made, and such selections need not be better, smaller, or otherwise preferable to other selections.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

The following terms and definitions are provided:

Agitator: A mechanical device that breaks down agglomerates into smaller primary particles by promoting separation of heavy/coarse particles from the light/fine particles through agitation and/or scrubbing.

Agglomeration: A term used to describe the tendency of primary particles to combine in clusters or clumps in solution, thereby forming larger “agglomerates” of the primary particles. “Agglomerates” is a term used to describe the agglomerated primary particles.

Chemical Dispersant: A chemical agent used to break down agglomerates into smaller primary particles by promoting separation of fine particles from coarse particles throughout the medium.

Gangue: Undesirable minerals/compounds that are present in lithium-containing materials that are separated from lithium compounds using a method and/or system according to aspects of the present disclosure. Exemplary gangue compounds can include, but are not limited to, carbonate compounds (e.g., calcium-containing compounds, such as calcite, dolomite, and the like), and aluminum compounds, iron compounds, potassium compounds, magnesium compounds, sodium compounds, or any combination thereof.

Gravity Concentrator: A device that separates gangue particles from fine/light particles by subjecting them to a centrifugal force.

Homogenizing: A term used to describe the uniform distribution of particles in a medium by promoting separation of fine particles from coarse particles.

Pre-treated Feedstock: A feedstock having greater particle dispersion relative to the lithium-containing material subjected to a method according to aspects of the disclosure. In some aspects, the lithium-containing material includes, but is not limited to, lithium-containing claystone.

Separating Apparatus: A mechanical device that breaks down agglomerates into smaller primary particles by promoting separation of heavy/coarse particles from the light/fine particles through agitation.

### II. Introduction

The transportation industry is one of the main contributors to climate change; thus, electric vehicles have the potential to reduce carbon emissions and mitigate the effects of climate change. Furthermore, cobalt, manganese, nickel, graphite, and lithium, are used to produce the batteries that power electric vehicles. For this reason, and additional reasons related to the transition into sustainable energy sources, there has been an exponential rise in the demand for these resources. Lithium, particularly, is a primary target for rechargeable batteries because of its high reactivity and electrochemical potential.

Conventional extraction methods used for extracting lithium for lithium-containing materials have many disadvantages. For example, direct acidification methods use sulfuric acid, hydrochloric acid, and hydrofluoric acid to leach lithium from lithium-containing claystone; however, downstream extractions after acid leaching remain challenging due to the presence of other ions (e.g., K⁺, Na⁺, Rb⁺, Cs⁺, Mn²⁺, Mg²⁺ and Al³⁺) in the pregnant leach solution. Also, direct acidification produces pure CO₂ upon dissolution, resulting in a large carbon footprint, and therefore goes against the purpose of mining lithium for use in green and sustainable energy production. Furthermore, conventional mineral processing techniques are undesirable for extracting lithium from claystones because of the fine/small particle size of its constituent minerals, which are not uniquely magnetic nor non-magnetic in their ores and have specific gravities similar to their associates gangue minerals. Accordingly, there is a need for environmentally sustainable and effective methods for extracting lithium from lithium-containing materials.

The present disclosure includes a novel method and system for removing one or more gangue compounds from lithium-containing materials. In some aspects, gangue from lithium-containing materials can be separated from the lithium compounds based on their specific density differences. In aspects disclosed herein, gravity concentration can be used to upgrade lithium while rejecting gangue minerals to optimize downstream lithium extraction processes.

### III. Method

Aspects of the present disclosure are directed to a method for removing one or more gangue compounds from lithium-containing materials. In some aspects, the one or more gangue compounds comprise one or more carbonate-containing compounds, such as calcium compounds like dolomite, calcite, and the like. Such calcium compounds can be separated from lithium-containing claystone present in a granulated material. In particular aspects, the lithium-containing claystone may comprise one or more lithium compounds and one or more gangue compounds, such as carbonate compounds (e.g., calcite, dolomite, and the like) and/or other calcium compounds (e.g., quartz, montmorillonite, feldspar, zeolite, and the like). In aspects disclosed herein, the one or more lithium compounds can have an average particle size that is smaller than the average particle size of the one or more gangue compounds. In some aspects, the lithium-containing claystone can further comprise gangue compounds selected from aluminum compounds, iron compounds, potassium compounds, magnesium compounds, sodium compounds, or any combination thereof.

In certain aspects, the method comprises homogenizing a granulated material comprising the lithium-containing claystone; obtaining a pre-treated feedstock from the granulated material using a separating apparatus; feeding the pre-treated feedstock into a gravity concentrator; and centrifuging the pre-treated feedstock to form a calcium material-concentrated layer and a lithium material-concentrated layer. In aspects disclosed herein, the method can be a batch, semi-batch, or continuous process.

In some aspects, the granulated material is homogenized using a homogenizing apparatus to obtain a uniform dispersion of agglomerated particles. In certain aspects, a homogenizing apparatus such as, but not limited to, a mixer, can be used to homogenize the granulated material. Exemplary mixers can include, but are not limited to, a blender, a rotary splitter, and the like. In particular aspects, the method comprises homogenizing the granulated material using one or more rotary splitters, such as, but not limited to, a Sepor 48″ Rotary Sample Splitter, a Humboldt Riffle-Type Splitter (Model H-3987), or a combination thereof.

In aspects disclosed herein, the pre-treated feedstock can be obtained by using a separating apparatus such as, but not limited to, a sieve, to screen the granulated material and thus separate the coarse/heavy particles from the light/fine particles in the granulated material. In certain aspects, the pre-treated feedstock can be obtained from the granulated material by dry screening or wet screening the granulated material using the sieve. In some aspects, the sieve is a woven mesh, net, or perforated sheet material comprising a plurality of openings. In certain aspects, the dry and/or wet screening may comprise mechanically vibrating or gyrating the sieve. The size of each opening of the sieve typically ranges from 20 μm to 1000 μm, such as from 20 μm to 900 μm, 20 μm to 800 μm, 20 μm to 700 μm, 20 μm to 600 μm, 20 μm to 500 μm, 20 μm to 400 μm, 20 μm to 300 μm, 20 μm to 200 μm, 20 μm to 100 μm, 20 μm to 75 μm, 20 μm to 50 μm.

In certain aspects, the separating apparatus can be an agitator, which induces motion in a fluid medium and can provide for the abrasion and fragmentation of agglomerated particles by agitation and/or scrubbing. In some aspects, the agitator can provide a pre-treated feedstock by producing a uniform dispersion of particles through decreasing the size of the agglomerated particles in the coarse fraction of the granulated material. Primary particles can thereby be released and redistributed into a fine fraction of the granulated material. Without being bound by a single theory of operation, the agglomerated particles can be broken down by subjecting them to compressive stress and shear forces (e.g., attrition scrubbing, ball milling, and the like). In aspects disclosed herein the agitator can be, but is not limited to, a mill (e.g., a ball mill, an attrition mill, a rod mill, a vertical mill, a disk pulverizer, and the like), or other component capable of separating the granulated material to obtain the pre-treated feedstock.

In some aspects, the pre-treated feedstock can be obtained by performing attrition scrubbing via an attrition mill. In particular aspects, attrition scrubbing can be performed using at an attrition speed ranging from 100 rpm to 1000 rpm, such as from 200 rpm to 1000 rpm, 300 rpm to 1000 rpm, 400 rpm to 1000 rpm, 500 rpm to 1000 rpm, 600 rpm to 1000 rpm, 700 rpm to 1000 rpm, 800 rpm to 1000 rpm. In particular aspects disclosed herein, attrition scrubbing can be performed by, for example (but not limited to), a S-1 Series Union Process Attrition Mill (231002) comprising a 1.5 gallon grinding chamber, steel beads (¼″), and mass of 1.8952 kilograms.

In certain aspects, the method may further comprise mixing a chemical dispersant with the granulated material. In some such aspects, the chemical dispersant can be combined with the granulated material prior to obtaining the pre-treated feedstock. In some aspects, the chemical dispersant can be combined with the granulated material in the mixer used to homogenize the granulated material and/or it can be added to an agitator used to obtain the pre-treated feedstock. In particular aspects, the chemical dispersant can be introduced into a grinding chamber of the agitator, with representative aspects involving adding the chemical dispersant to an attrition mill while attrition scrubbing the granulated material. In yet other aspects, the chemical dispersant can be mixed with the granulated material after attrition scrubbing. In particular aspects, the granulated material can be mixed with the chemical dispersant prior to attrition scrubbing. In aspects disclosed herein, the chemical dispersant can be a sodium polyphosphate, a tannin, a sodium polymethacrylate, or any combination thereof. In particular aspects disclosed herein, the sodium polyphosphate is sodium hexametaphosphate. In other aspects, the chemical dispersant is oak tannin.

In some aspects, the chemical dispersant can be added in an amount ranging from 5 grams of chemical dispersant per kilogram of lithium-containing claystone to 50 grams of chemical dispersant per kilogram of lithium-containing claystone, such as from 10 grams of chemical dispersant per kilogram of lithium-containing claystone to 40 grams of chemical dispersant per kilogram of lithium-containing claystone, 15 grams of chemical dispersant per kilogram of lithium-containing claystone to 30 grams of chemical dispersant per kilogram of lithium-containing claystone.

Without being bound by single theory of operation, it currently is believed that using the chemical dispersant can increase the overall negative charge at the clay particle's interactive edges (e.g., by substituting sodium cations), to thereby increase the thickness of the electrical double layer and separate the agglomerated particles. In particular aspects disclosed herein, the agglomerated particles are dispersed into smaller primary particles that are more uniformly distributed throughout the medium, which makes them more susceptible to stratification into light and heavy fractions described herein.

Particles in the granulated material, particularly lithium-containing materials (e.g., lithium-containing claystone), tend to cluster together to form larger agglomerates having a greater distribution of particles in the coarse fraction of the medium comprising lithium-containing materials because of their larger size. The pre-treated feedstock disclosed herein, however, comprises deagglomerated particles of lithium-containing material, which are uniformly distributed throughout the medium.

In certain aspects, the pre-treated feedstock is fed into a gravity concentrator. In aspects disclosed herein, the gravity concentrator can facilitate separating particles into layers of dense/coarse particles and fine/light particles. Devices that can facilitate this separation can include, but are not limited to: (i) jigging concentrators, which uses a vertical expansion and contraction of a bed of particles by a pulse of fluid to facilitate separation; (ii) shaking concentrators, which generate a horizontal motion to a solids-fluid stream and thereby fluidize the particles causing separation/segregation of dense/coarse and light/fine particles; or (iii) flowing film concentrators, which can separate particles into layers of dense/coarse particles and fine/light particles by increasing the specific gravity difference between heavier particles and lighter particles via the centrifugal force.

In particular aspects disclosed herein, the pre-treated feedstock is fed into a flowing film concentrator such as, but not limited to, a centrifugal separator or a multigravity separator. In certain aspects, the centrifugal force of the centrifugal separator acts on the lithium-containing claystone by increasing the specific gravity difference between heavier particles and lighter particles in the lithium-containing claystone. In certain aspects, the centrifugal separator can be a Falcon Concentrator comprising a smooth sided bowl or a Gekko Inline Spinner comprising a riffled bowl and a cutter bar to create turbulence near the bowl surface. As such, the coarse/heavy particles can be captured along the surface of the bowl and the fine/light particles can be ejected over the bowl. In other aspects, the pre-treated feedstock can be fed to a multigravity separator comprising a cylindrical drum that can separate the lighter particles from the heavier particles by using the flowing film and shaking table principle. For example, the cylindrical drum is rotated to exert a force greater than normal gravity on the particles in the flowing film and the vibrated or gyrated action adds an additional force to increase the separation.

In certain aspects, the pre-treated feedstock fed into the gravity concentrator can comprise a pulp density ranging from 5 wt. % solids to 30 wt. % solids, such as 5 wt. % solids to 30 wt. % solids, 6 wt. % solids to 30 wt. % solids, 7 wt. % solids to 30 wt. % solids, 8 wt. % solids to 30 wt. % solids, 9 wt. % solids to 30 wt. % solids, 10 wt. % solids to 30 wt. % solids, 11 wt. % solids to 30 wt. % solids, 12 wt. % solids to 30 wt. % solids, 13 wt. % solids to 30 wt. % solids, 14 wt. % solids to 30 wt. % solids, 15 wt. % solids to 30 wt. % solids, 16 wt. % solids to 30 wt. % solids, 17 wt. % solids to 30 wt. % solids, 18 wt. % solids to 30 wt. % solids, 19 wt. % solids to 30 wt. % solids, 20 wt. % solids to 30 wt. % solids, 21 wt. % solids to 30 wt. % solids, 22 wt. % solids to 30 wt. % solids, 23 wt. % solids to 30 wt. % solids, 24 wt. % solids to 30 wt. % solids, 25 wt. % solids to 30 wt. % solids, 26 wt. % solids to 30 wt. % solids, 27 wt. % solids to 30 wt. % solids, 28 wt. % solids to 30 wt. % solids, or 29 wt. % solids to 30 wt. % solids.

In aspects disclosed herein, the feed mass of the pre-treated feedstock can be fed into the gravity concentrator at a rate ranging from 5 liters/hour to 20 liters/hour, such as from 6 liters/hour to 20 liters/hour, 7 liters/hour to 20 liters/hour, 8 liters/hour to 20 liters/hour, 9 liters/hour to 20 liters/hour, 10 liters/hour to 20 liters/hour, 11 liters/hour to 20 liters/hour, 12 liters/hour to 20 liters/hour, 13 liters/hour to 20 liters/hour, 14 liters/hour to 20 liters/hour, 15 liters/hour to 20 liters/hour, 16 liters/hour to 20 liters/hour, 17 liters/hour to 20 liters/hour, 18 liters/hour to 20 liters/hour, 19 liters/hour to 20 liters/hour. In preferable aspects, the feed mass of the pre-treated feedstock can be fed into the gravity concentrator at a rate of 5 liters/hour, 6 liters/hour, 7 liters/hour, 8 liters/hour, 9 liters/hour, 10 liters/hour, 11 liters/hour, 12 liters/hour, 13 liters/hour, 14 liters/hour, 15 liters/hour, 16 liters/hour, 17 liters/hour, 18 liters/hour, 19 liters/hour, or 20 liters/hour.

In aspects disclosed herein, the pre-treated feedstock can be centrifuged by subjecting the pre-treated feedstock to a gravitational force ranging from 50 G to 600 G, such as from 75 G to 600 G, 100 G to 600 G, 125 G to 600 G, 150 G to 600 G, 175 G to 600 G, 200 G to 600 G, 225 G to 600 G, 250 G to 600 G, 275 G to 600 G, 300 G to 600 G, 325 G to 600 G, 350 G to 600 G, 375 G to 600 G, 300 G to 600 G, 325 G to 600 G, 350 G to 600 G, 375 G to 600 G, 400 G to 600 G, 425 G to 600 G, 450 G to 600 G, 475 G to 600 G, 500 G to 600 G, 525 G to 600 G, 550 G to 600 G, or 575 G to 600 G.

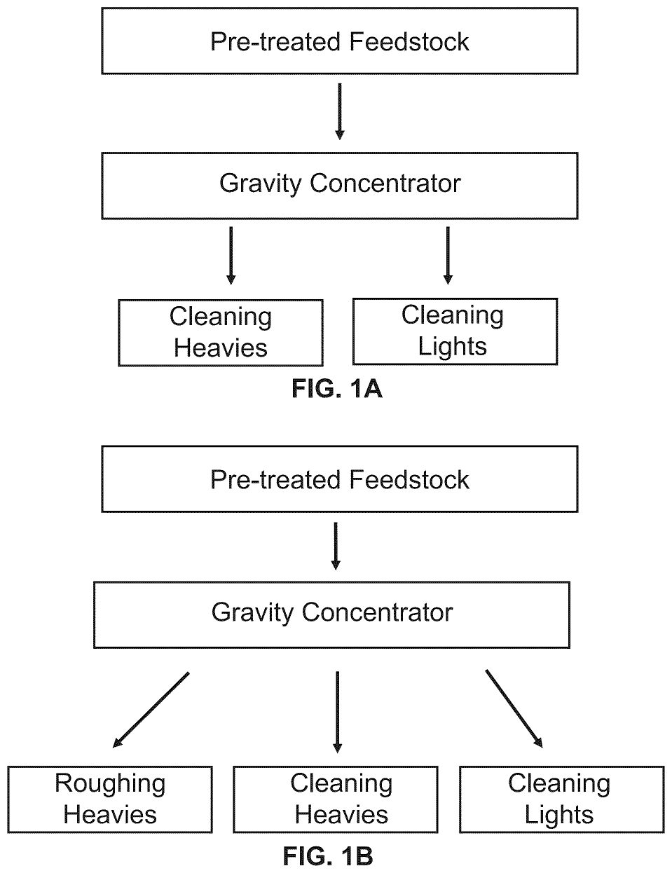

Without being bound to a single theory of operation, it currently is believed that the centrifugal force applied can act on fine/small particles by increasing the specific gravity difference between heavier particles and lighter particles. In some aspects, centrifuging the pre-treated feedstock can form two or more layers, wherein a first layer comprises coarse/heavy particles and a second layer comprises fine/light particles. In some aspects, a cleaning stage can form a first stream comprising a first layer comprising the coarse/heavy particles formed on the surface of the concentrator bowl and a second stream comprising the second layer comprising the finer/light particles is ejected upward over the bowl of the gravity concentrator. For example, FIG. 1A shows obtaining a pre-treated feedstock; and feeding the pre-treated feedstock to a gravity concentrator to produce a cleaning heavies stream and a cleaning lights stream.

In some aspects, the method may comprise a roughing stage, wherein the pre-treated feedstock can be fed into the gravity concentrator for roughing to remove one or more dense gangue minerals. In one aspect, the method may comprise a roughing stage and a cleaning stage to form (i) a first stream comprising coarse/heavy particles provided by the roughing stage; (ii) a second stream comprising heavy/coarse particles from the cleaning stage; and (iii) a third steam comprising fine/light particles from the cleaning stage. For example, FIG. 1B shows obtaining a pre-treated feedstock; and feeding the pre-treated feedstock to a gravity concentrator to produce a roughing heavies stream, a cleaning heavies stream, and a cleaning lights stream.

In aspects disclosed herein, the compounds in at least one layer obtained from the gravity concentrator can have an average particle size that is smaller than the compounds of the second layer obtained from the gravity concentrator. In certain aspects, at least one layer obtained from the gravity concentrator can comprise lithium compounds having an average particle size that is smaller than the average particle size of the second layer obtained from the gravity concentrator, the second layer comprising gangue compounds (e.g., calcium compounds, such as calcite). In some aspects, the second layer may further comprise gangue compounds like aluminum compounds, iron compounds, potassium compounds, magnesium compounds, sodium compounds, or any combination thereof.

In certain aspects, the method disclosed herein can produce a second layer that constitutes a calcium-material concentrated layer having one or more calcium compounds present in an amount relative to the lithium-containing material (e.g., lithium-containing claystone) ranging from greater than 50 wt. %, such as from 50 wt. % to 95 wt. %, 55 wt. % to 95 wt. %, 60 wt. % to 95 wt. %, 65 wt. % to 95 wt. %, 70 wt. to 95 wt. %, 75 wt. % to 95 wt. %, 80 wt. % to 95 wt. %, 85 wt. % to 95 wt. %, 90 wt. % to 95 wt. %. In preferable aspects, the method disclosed herein can produce a calcium-material concentrated layer having one or more calcium compounds present in an amount of 61 wt. %, 62 wt. %, 63 wt. %, 64 wt. %, 65 wt. %, 66 wt. %, 67 wt. %, 68 wt. %, 69 wt. %, 70 wt. %, 71 wt. %, 72 wt. %, 73 wt. %, 74 wt. %, 75 wt. %, 76 wt. %, 77 wt. %, 78 wt. %, 79 wt. %, 80 wt. %, 81 wt. %, 82 wt. %, 83 wt. %, 84 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, or 99 wt. %.

In aspects disclosed herein, the method disclosed herein can produce a lithium-concentrated layer having one or more lithium compounds relative to the lithium-material (e.g., lithium-containing claystone) present in an amount ranging from greater than 50 wt. %, such as from 50 wt. % to 95 wt. %, 55 wt. % to 95 wt. %, 60 wt. % to 95 wt. %, 65 wt. % to 95 wt. %, 70 wt. to 95 wt. %, 75 wt. % to 95 wt. %, 80 wt. % to 95 wt. %, 85 wt. % to 95 wt. %, 90 wt. % to 95 wt. %. In preferable aspects, the method disclosed herein can produce lithium-concentrated layer having one or more lithium compounds in an amount 61 wt. %, 62 wt. %, 63 wt. %, 64 wt. %, 65 wt. %, 66 wt. %, 67 wt. %, 68 wt. %, 69 wt. %, 70 wt. %, 71 wt. %, 72 wt. %, 73 wt. %, 74 wt. %, 75 wt. %, 76 wt. %, 77 wt. %, 78 wt. %, 79 wt. %, 80 wt. %, 81 wt. %, 82 wt. %, 83 wt. %, 84 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, or 99 wt. %.

In aspects disclosed herein, the method can further comprise one or more leaching leching processes for increasing elemental recovery. In particular aspects, the method disclosed herein facilitates elemental recovery from the one or more leaching processes. In some aspects, the one or more leaching processes are performed downstream.

### IV. System

Also disclosed herein are aspects of a system for removing gangue compounds from a lithium-containing material. In some aspects of the disclosure, the system can comprise a separating apparatus and a means for separating one or more calcium compounds from one or more lithium compounds present in the lithium-containing material. In certain aspects, the one or more calcium compounds are separated from the one or more lithium compounds present in the lithium containing material based on a difference in specific gravity.

In some aspects, the system may comprise a separating apparatus for homogenizing a granulated material to obtain a uniform dispersion of agglomerated particles. In certain aspects, a homogenizing apparatus such as, but not limited to, a mixer, can be used to homogenize the granulated material. In aspects disclosed herein, the mixer can be, but is not limited to, a blender, a rotary splitter, and the like. Exemplary rotary splitters include, but are not limited to, a Sepor 48″ Rotary Sample Splitter and a Humboldt Riffle-Type Splitter (Model H-3987).

In certain aspects, the system may comprise a separating apparatus for separating course/heavy particles from fine/light particles such as, but is not limited to, a sieve. The sieve may comprise for example, but is limited to, a woven mesh, net, or perforated sheet material comprising a plurality of opening. In certain aspects, the sieve can be mechanically vibrated or gyrated to further deagglomerate the lithium-containing material. In aspects disclosed herein, The size of each opening of the sieve typically ranges from 20 μm to 1000 μm, such as from 20 μm to 900 μm, 20 μm to 800 μm, 20 μm to 700 μm, 20 μm to 600 μm, 20 μm to 500 μm, 20 μm to 400 μm, 20 μm to 300 μm, 20 μm to 200 μm, 20 μm to 100 μm, 20 μm to 75 μm, or 20 μm to 50 μm.

In aspects disclosed herein, the system may comprise a separating apparatus such as, but is not limited to, an agitator, wherein the agitator induces motion in a fluid medium and can provide for the abrasion and fragmentation of agglomerated particles. In some aspects, the agitator can obtain pre-treated feedstock by producing a uniform dispersion by decreasing the size of the agglomerated particles in the coarse fraction of the granulated material by releasing the primary particles and redistributing the smaller dispersed primary particles into a fine fraction of the granulated material. In certain aspects, the agitator can be for example, but is not limited to, a mixer, a mill or other component capable of separating the granulated material to obtain the pre-treated feedstock. In certain aspects, the mill can be a stirred mill, an attrition mill, a ball mill, and the like. In certain aspects, the mill can be a vertically configured mill such as, but not limited to, an attrition mill comprising a grinding chamber, steel beads, and stirring shaft suspension. For example, a S-1 Series Union Process Attrition Mill (231002) equipped with a 1.5-gallon grinding chamber, ¼″ steel beads, a mass of 1.8952 kg, and having a stirring shaft suspension of ½″ from the base of the grinding chamber.

The system may comprise any suitable means capable of separating one or more compounds based on gravity separation. In some aspects, a gravity concentrator such as, but not limited to, a jigging concentrator, a shaking concentrator, or a flowing film concentrator can be used to separate one or more compounds from the lithium containing-material. In aspects disclosed herein, the gravity concentrator can provide for a gravitational force ranging from 50 G to 600 G, such as from 75 G to 600 G, 100 G to 600 G, 125 G to 600 G, 150 G to 600 G, 175 G to 600 G, 200 G to 600 G, 225 G to 600 G, 250 G to 600 G, 275 G to 600 G, 300 G to 600 G, 325 G to 600 G, 350 G to 600 G, 375 G to 600 G, 300 G to 600 G, 325 G to 600 G, 350 G to 600 G, 375 G to 600 G, 400 G to 600 G, 425 G to 600 G, 450 G to 600 G, 475 G to 600 G, 500 G to 600 G, 525 G to 600 G, 550 G to 600 G, or 575 G to 600 G.

In certain aspects, the flowing film concentrator is a multigravity separator or a centrifugal separator. In some aspects, the multigravity separator can comprise a cylindrical drum and an apparatus for vibrating or gyrating the cylindrical drum. The multigravity separator can separate the lighter particles from the heavier particles by using the flowing film and shaking table principle. As such, the cylindrical drum is rotated to exert a force greater than normal gravity on the particles in the flowing film and the vibrated or gyrated action adds an additional force to increase the separation. In aspects disclosed herein, the centrifugal separator comprises a bowl and configured to an apparatus for spinning the bowl. In certain aspects, the centrifugal separator can be a Falcon concentrator comprising a smooth sided bowl or a Gekko inline spinner comprising a riffled bowl and a cutter bar to create turbulence near the bowl surface. In certain aspects, the bowl can receive feed continuously, semi-batch, which generates concentrates during specific rinse periods. In some aspects, the centrifugal separator does not require any fluidization water. In one exemplary aspect, the gravity concentrator is a UF L40 Falcon concentrator comprising an ultrafine concentrating bowl.

In certain aspects, the centrifugal separator may comprise a migration zone at the bottom portion of the bowl and a retention zone at the top portion of the bowl. Typically, the pre-treated feedstock is directed upward forming a first layer comprising the coarse fraction of the pre-treated feedstock begins to form at a portion of the migration zone and into the retention zone; and a second layer comprising the fine fraction of the pre-treated feedstock flows out of the bowl. In some aspects, the impeller can rotate the bowl of the centrifugal separator at rotation speed ranging from 1000 rpm to 5000 rpm, such as from 1200 rpm to 5000 rpm, 1400 rpm to 5000 rpm, 1600 rpm to 5000 rpm, 1800 rpm to 5000 rpm, 2000 rpm to 5000 rpm, 2200 rpm to 5000 rpm, 2400 rpm to 5000 rpm, 2600 rpm to 5000 rpm, 2800 rpm to 5000 rpm, 3000 rpm to 5000 rpm, 3200 rpm to 5000 rpm, 3400 rpm to 5000 rpm, 3600 rpm to 5000 rpm, 3800 rpm to 5000 rpm, 4000 rpm to 5000 rpm, 4200 rpm to 5000 rpm, 4400 rpm to 5000 rpm, 4600 rpm to 5000 rpm, or 4800 to 5000 rpm.

### V. Overview of Several Aspects

Disclosed herein is a method for removing one or more calcium compounds from a lithium-containing claystone, the method comprising: homogenizing a granulated material comprising the lithium-containing claystone; obtaining a pre-treated feedstock from the granulated material using a separating apparatus; feeding the pre-treated feedstock into a gravity concentrator; and centrifuging the pre-treated feedstock to form a calcium material-concentrated layer and a lithium material-concentrated layer.

In any or all aspects, the lithium-containing claystone comprises a mixture of one or more lithium compounds and the one or more calcium compounds.

In any or all of the above aspects, the one or more lithium compounds have an average particle size that is smaller than an average particle size of the one or more calcium compounds.

In any or all of the above aspects, the lithium-containing claystone further comprises aluminum compounds, iron compounds, potassium compounds, magnesium compounds, sodium compounds, or any combination thereof.

In any or all of the above aspects, homogenizing the granulated material comprising the lithium-containing claystone comprises using a mixer to homogenize the granulated material.

In any or all of the above aspects, the separating apparatus is a sieve comprising one or more screens having a plurality of openings, separating each opening of the plurality has a size ranging from 20 μm to 1000 μm and the method further comprises wet screening with the sieve.

In any or all of the above aspects, the separating apparatus is an agitator and the method further comprises attrition scrubbing the granulated material.

In any or all of the above aspects, the method further comprises mixing a chemical dispersant with the granulated material prior to obtaining the pre-treated feedstock.

In any or all of the above aspects, the chemical dispersant is added in an amount ranging from 5 to 50 grams per kilogram of lithium-containing claystone.

In any or all of the above aspects, the chemical dispersant is a sodium polyphosphate, a tannin, a sodium polymethacrylate, or any combination thereof.

In any or all of the above aspects, the sodium polyphosphate is sodium hexametaphosphate and/or wherein the tannin is oak tannin.

In any or all of the above aspects, the pre-treated feedstock comprises a pulp density ranging from 5 wt. % to 30 wt. % and a feed mass is fed to the gravity concentrator at a rate ranging from 5 liters/hour to 20 liters/hour.

In any or all of the above aspects, the gravity concentrator is a flowing film concentrator.

In any or all of the above aspects, the flowing film concentrator is a centrifugal separator or a multi-gravity separator.

In any or all of the above aspects, the centrifuging the pre-treated feedstock comprises subjecting the pre-treated feedstock to a gravitational force ranging from 50 G to 600 G.

In some aspects, a method for removing one or more calcium compounds from a lithium-containing claystone is disclosed, the method comprising: feeding the lithium-containing claystone into a separating apparatus, wherein the lithium-containing claystone has a calcium concentration ranging from greater than 10,000 mg/kg to 1,000,000 mg/kg; wet screening using the sieve to obtain a pre-treated feedstock from the lithium-containing claystone; subjecting the pre-treated feedstock to a centrifugal force using a gravity concentrator; and producing a calcium material-concentrated layer having one or more calcium compounds in an amount ranging from 50 wt. % to 90 wt. %; and a lithium material-concentrated layer having one or more lithium compounds in an amount ranging from 50 wt. % to 90 wt. %.

In any or all of the above aspects, the one or more lithium compounds have an average particle size that is smaller than an average particle size of the one or more calcium compounds.

In any or all of the above aspects, the wet screening comprises obtaining the pre-treated feedstock from extraneous particles using the sieve, wherein the sieve has one or more screens having a plurality of openings, wherein each opening of the plurality has a size ranging from 20 μm to 1000 μm.

In any or all of the above aspects, the method further comprises attrition scrubbing the lithium-containing material to deagglomerate the pre-treated feedstock from the extraneous particles prior to the subjecting the pre-treated feedstock to the centrifugal force.

In any or all of the above aspects, the attrition scrubbing comprises using an attrition mill at an attrition speed ranging from 100 rpm to 500 rpm.

In any or all of the above aspects, the method further comprises mixing a chemical dispersant with the pre-treated feedstock prior to subjecting the pre-treated feedstock to the centrifugal force.

In any or all of the above aspects, the chemical dispersant is added in an amount ranging from 5 to 50 grams per kilogram of lithium-containing claystone.

In any or all of the above aspects, the chemical dispersant is a sodium polyphosphate, a tannin, a sodium polymethacrylate, or any combination thereof.

In any or all of the above aspects, the sodium polyphosphate is sodium hexametaphosphate and/or wherein the tannin is oak tannin.

In any or all of the above aspects, subjecting the pre-treated feedstock to the centrifugal force using the gravity separator comprises using a gravitational force ranging from 50 G to 600 G.

In any or all of the above aspects, the gravity concentrator is a flowing film concentrator.

In any or all of the above aspects, the flowing film concentrator is a centrifugal separator or a multi-gravity separator.

Also disclosed herein is a system for removing one or more calcium compounds from a lithium-containing claystone, the system comprising: a separating apparatus; and a means for separating one or more calcium compounds from one or more lithium compounds present in the lithium-containing claystone, wherein the separating is based on a difference of a specific gravity of the one or more calcium compounds and a specific gravity of the one or more lithium compounds.

In any or all aspects, the separating apparatus is a sieve comprising one or more screens having a plurality of openings, wherein each opening of the plurality has a size ranging from 20 μm to 1000 μm.

In any or all of the above aspects, the system further comprises an attrition mill.

In any or all of the above aspects, the attrition mill comprises a grinding chamber, a stirring shaft suspension, and one or more steel beads.

Also disclosed is a method for removing one or more calcium compounds from a lithium-containing claystone, the method comprising: feeding the lithium-containing claystone into the system of any or all the above aspects of the system; and producing a calcium material-concentrated layer and a lithium material-concentrated layer.

In any or all aspects, the calcium material-concentrated layer comprises one or more calcium compounds in an amount ranging from 50 wt. % to 90 wt. % of the lithium-containing claystone; and the lithium material-concentrated layer comprises one or more lithium compounds in an amount ranging from 50 wt. % to 90 wt. % of the lithium-containing claystone.

In any or all of the above aspects, the lithium-containing claystone further comprises aluminum compounds, iron compounds, potassium compounds, magnesium compounds, sodium compounds, or any combination thereof.

In any or all of the above aspects, the method further comprises adding a chemical dispersant to the system according to any or all of the above-described aspects.

In any or all of the above aspects, the chemical dispersant is added in an amount ranging from (5 g)/(kg of lithium-containing claystone) to (50 g)/(kg of lithium-containing claystone).

In any or all of the above aspects, the chemical dispersant is a sodium polyphosphate, a sodium polyphosphate, a sodium polyphosphate, an oak tannin, a sodium polymethacrylate, or any combination thereof.

In any or all of the above aspects, the sodium polyphosphate is sodium hexametaphosphate.

### VI. Examples

Aspects of the present teachings can be further understood in light of the following examples.

Materials: A first calcium-rich claystone having swelling properties, a second calcium-rich claystone with no swelling properties, and a magnesium-rich claystone were subjected to aspects of the method and system disclosed herein. The claystones were homogenized and representative samples were generated using a Sepor 48″ Rotary Splitter and the Humboldt Riffle-Type Splitter (Model H-3987 of 0.66″ Max Material Size).

Particle Size Distribution: Particle size distribution analysis was performed on all three claystone by wet screening over a set of five laboratory screens. Mineralogical investigations were carried out on the feed material and on samples from the various product streams from the gravity concentrator by X-Ray Diffraction (XRD) analysis using the Bruker D8 Advance A25 Diffractometer with a Cu-anode radiation source where each dry solid sample was placed on the silicon holder, and the 2-theta range was scanned between 5 and 55 degrees at a continuous scan rate of 2.4 degrees per minute. The reference database utilized was PDF 4+2009. Scanning Electron Microscopy (SEM) and Energy Dispersive X-Ray Spectroscopy (SEM/EDS) were conducted using a Jeol JSM-7100F field emission scanning electron microscope equipped with Oxford Instruments X-Max N Silicon Drift Detector. Using AZtec software, point ID analysis and true element mapping were performed during back Scatter Electron (BSE) imaging, which was carried out at a working distance of 10 mm and an accelerating voltage of 15 kV.

Elemental Analysis: Inductively Coupled Plasma Atomic Emission Spectroscopy (ICP-OES) was utilized to determine the concentrations of lithium and co-existing ions in solution samples derived from the acid digestion of dried solid samples from both the feed material and separated products, employing the aqua regia method (Peña-Icart et al., 2011; Wilson et al., 1997). Wet screened (−500 μm) feed material was subjected to gravity concentration either directly or conditioned with a chemical dispersant, wherein the slurry was mechanically agitated at a speed of 500 rpm for about 15 minutes with 2 grams of sodium hexametaphosphate.

Attrition Scrubbing: Pre-treated feedstock was obtained via attrition scrubbing using a vertically configured stirred mill. Specifically, a laboratory SD-1 model of the S-1 Series Union Process Attrition Mill (231002) equipped with a 1.5-gallon grinding chamber, steel beads (size of ¼″) and mass of 1.8952 kg was used to obtain the pre-treated feedstock. Attrition scrubbing was performed at 10% solids pulp density with feed mass of 250 g with stirring shaft suspension of about ½″ from the base of the grinding chamber at varied speed and time depending on the claystone.

Chemical Dispersant: Unlike that with the wet-screened feed evaluations, examples further comprising adding a chemical dispersant comprised adding the chemical dispersant into the grinding chamber while attrition scrubbing. In some examples, a synergistic effect on separation efficiency was observed using attrition scrubbing in conjunction with a chemical dispersant. Four different evaluations were performed on all three claystone as described in Table 1 below to obtain the pre-treated feedstock. To ensure reproducibility of results, each experiment was carried out in triplicate.

TABLE 1

| Evaluation | |
|---|---|
| Number | Procedure |
| 1 | No Attrition Scrubbing on Sample (Wet Screen −500) |
| 2 | No Attrition Scrubbing with Dispersant (Wet Screen −500) |
| 3 | Attrition Scrubbing Without Chemical Dispersion |
| 4 | Attrition Scrubbing with Chemical Dispersion |

Gravity Concentrator: In some of the following examples, a Sepro L40 Falcon gravity concentrator equipped with a smooth walled concentrating bowl of diameter 4″ was used. In the examples described herein, the less dense fraction is thrown over the bowl to report in the overflow launder as the lights section. An ultrafine concentrating bowl at a speed of 2333 rpm, feed mass of 50 g, and pulp density of 10% solids was used. For enhanced separation efficiency, a 2-stage separation approach was adopted, wherein roughing was used to eject as much dense gangue minerals as possible, followed by a subsequent cleaning step to further remove unrecovered gangue from the light fraction of the roughing stage. This protocol yielded three product streams for each evaluation; the heavies from roughing (RH), heavies from cleaning (CH), and the lights from the cleaning stage (CL), this last fraction comprising the desired product.

Separation Analysis: The determination of metal recovery (R) was expressed as a percentage using Equation 1 below, where C is the mass of concentrate; c is the assay of concentrate; T is the mass of tails sample; and t is the assay of the tails sample.

$$R = \frac{Cc}{Cc + Tt} \qquad Equation 1$$

The enrichment ratio is shown below in Equation 2, where r is the enrichment ratio; f is the feed assay; and c is the concentrate assay.

$$r = \frac{c}{f} \qquad Equation 2$$

In some aspects, the process performance of the centrifuging technique was evaluated by the efficiency of separation (Eₛ), as shown in Equation 4, while the recoveries of elemental species after applying a method according to the present disclosure, followed by leaching, is determined according to Equation 3:

$$R = \frac{Cc}{Ff} * 100 \% \qquad Equation 3$$

where C is the mass of concentrate (in grams), c is the assay of concentrate (in ppm), F is the mass of the feed sample (in grams), and f represents the assay of the feed sample (in ppm). The efficiency of separation of two constituents physically separated from each other is determined according to Equation 4:

$$Es = R - Rg \qquad Equation 4$$

where R is the percentage of the valuable constituent recovered, and R_{g} is the waste yield percentage into the concentrate stream.

Carbon analysis: Carbonate mineral removal, which estimates the efficiency of the gravity separation technique, was evaluated using a TGA Q50-1474 thermal gravimetric analyzer. The TGA quantifies carbon in the clay samples before and after separation by assessing the weight loss during decomposition from 25° C. to 700° C. The data was analyzed using TA Instruments' Universal Analysis software to delineate the decomposition stages and precisely measure carbon loss.

Acid consumption: In the acidification process of extracting lithium from the clay resources, acid is consumed in reaction with carbonate minerals, producing byproducts of limited economic value. The acid consumption estimation was based on how much sulfuric acid was consumed per ton of material and the acid consumed per lithium leached. 5 ml each of PLS obtained after leaching the different materials were titrated against 0.1 M sodium hydroxide (NaOH) using phenolphthalein as an indicator, and the average titer values of triplicate titrations, at which a color change from clear to pink were observed for estimating acid consumed were recorded.

Response Surface Methodology: Response surface methodology using central composite design as factorial experimental design in the Minitab software Minitab® LLC (State College, Pennsylvania, United States, version 22.1) was used to investigate the effect of four leaching parameters; sulfuric acid concentration (A), leaching temperature (B), leaching time (C) and solid-liquid ratio (D), on metal recovery. In the experimental design, the parameters investigated were selected as numerical factors. Other leaching parameters, such as the feed particle size, were maintained at p80 of 38 μm, leached in a water bath (Amerex Instruments Inc. SK-929 model) agitated at a speed of 270 rpm throughout the experiments. Slurry samples were collected at set intervals and subjected to centrifugation to obtain the PLS for chemical analysis by ICP-OES. The individual recoveries of lithium, calcium, iron and magnesium were subsequently computed from the chemical assays using the recovery formula in Equation 3. The parameter levels and their corresponding values are presented in Table 2. The experimental design dictates 30 leaching experiments, as highlighted in Table 3.

TABLE 2

| | | | Coded Variables and Levels | | |
|---|---|---|---|---|---|
| Parameter | Units | Symbols | −1 | 0 | +1 |
| H₂SO₄ Conc. | M | A | 0.5 | 1.0 | 1.5 |
| Leaching | ° C. | B | 30 | 55 | 80 |
| Temperature | | | | | |
| Time | h | C | 0.5 | 4.25 | 8.0 |
| Solid-Liquid | % solids | D | 10 | 20 | 30 |
| Ratio | | | | | |

TABLE 3

| | | Acid conc | Temp | | S/L |
|---|---|---|---|---|---|
| Std Order | Run Order | (M) | (C.) | Time (h) | ratio (%) |
| 9 | 1 | 0.5 | 30 | 0.5 | 30 |
| 19 | 2 | 1 | 55 | 4.25 | 20 |
| 18 | 3 | 1 | 55 | 4.25 | 20 |
| 6 | 4 | 1.5 | 30 | 8 | 10 |
| 8 | 5 | 1.5 | 80 | 8 | 10 |
| 16 | 6 | 1.5 | 80 | 8 | 30 |
| 14 | 7 | 1.5 | 30 | 8 | 30 |
| 12 | 8 | 1.5 | 80 | 0.5 | 30 |
| 4 | 9 | 1.5 | 80 | 0.5 | 10 |
| 5 | 10 | 0.5 | 30 | 8 | 10 |
| 2 | 11 | 1.5 | 30 | 0.5 | 10 |
| 20 | 12 | 1 | 55 | 4.25 | 20 |
| 11 | 13 | 0.5 | 80 | 0.5 | 30 |
| 13 | 14 | 0.5 | 30 | 8 | 30 |
| 15 | 15 | 0.5 | 80 | 8 | 30 |
| 7 | 16 | 0.5 | 80 | 8 | 10 |
| 10 | 17 | 1.5 | 30 | 0.5 | 30 |
| 1 | 18 | 0.5 | 30 | 0.5 | 10 |
| 3 | 19 | 0.5 | 80 | 0.5 | 10 |
| 17 | 20 | 1 | 55 | 4.25 | 20 |
| 29 | 21 | 1 | 55 | 4.25 | 20 |
| 24 | 22 | 1 | 80 | 4.25 | 20 |
| 30 | 23 | 1 | 55 | 4.25 | 20 |
| 22 | 24 | 1.5 | 55 | 4.25 | 20 |
| 27 | 25 | 1 | 55 | 4.25 | 10 |
| 21 | 26 | 0.5 | 55 | 4.25 | 20 |
| 23 | 27 | 1 | 30 | 4.25 | 20 |
| 25 | 28 | 1 | 55 | 0.5 | 20 |
| 28 | 29 | 1 | 55 | 4.25 | 30 |
| 26 | 30 | 1 | 55 | 8 | 20 |

### Example 1

In this example, the mineralogy of different lithium-containing claystone samples was investigated by characterizing them using SEM-EDS and XRD techniques. More specifically, size morphology, composition, and the powder diffraction analysis of a first calcium-rich claystone, a second calcium-rich claystone, and a magnesium-rich claystone were investigated.

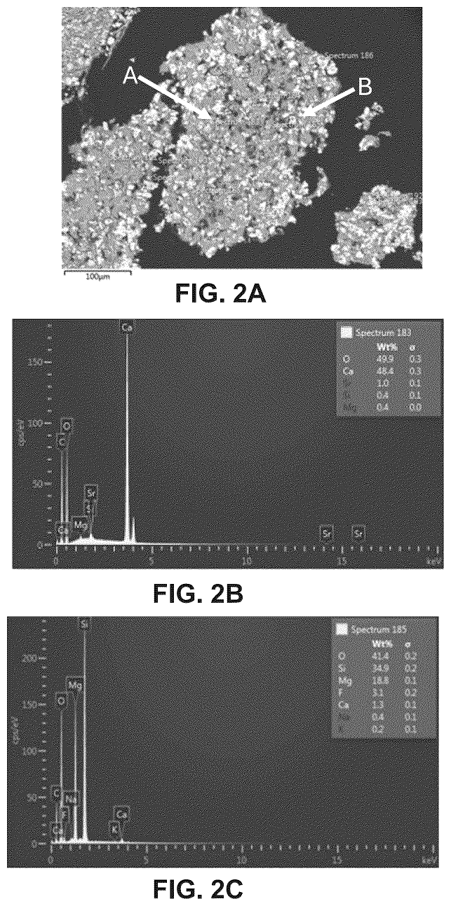

FIG. 2A is an SEM image showing the first calcium-rich claystone, which exhibits irregularly-shaped particles of different sizes. FIG. 2B is an energy dispersive x-ray spectra (EDS) showing the elemental analysis results of the first type of calcium-rich claystone (analyzed at the region noted with the arrow labeled “A” in FIG. 2A) comprising oxygen (49.9 wt. %) having a σ of 0.3; calcium (48.4 wt. %) having a σ of 0.2; strontium (1.0 wt. %) having a σ of 0.1; silicon (0.4 wt. %) having a σ of 0.1; and magnesium (0.4 wt. %) having a σ of 0. FIG. 2C is an energy dispersive x-ray spectra (EDS) showing the elemental analysis results of the first calcium-rich claystone (analyzed at the region noted with the arrow labeled “B” in FIG. 2A) comprising oxygen (41.4 wt. %) having a σ of 0.2; silicon (34.9 wt. %) having a σ of 0.2; magnesium (18.8 wt. %) having a σ of 0.1; fluorine (3.1 wt. %) having a σ of 0.1; calcium (1.3 wt. %) having a σ of 0.1; sodium (0.4 wt. %) having a σ of 0.1; and potassium (0.2 wt. %) having a σ of 0.1.

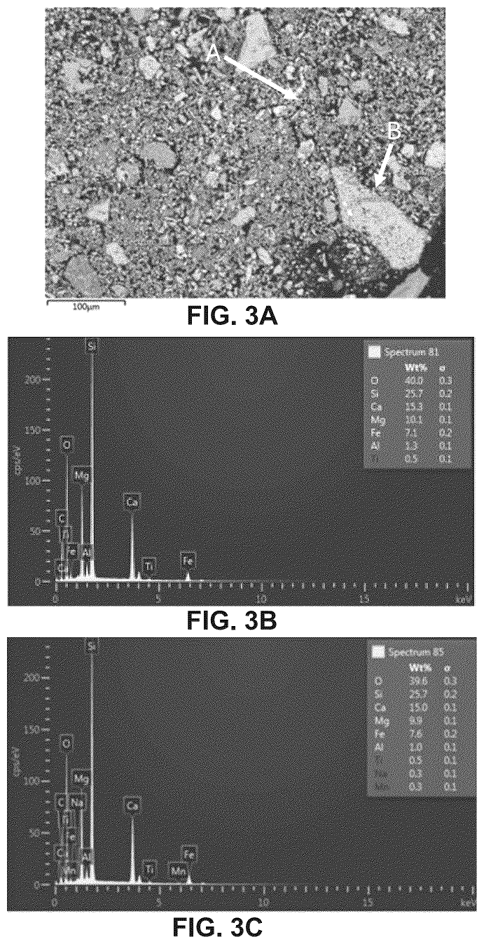

FIG. 3A is a scanning electron microscopy (SEM) image showing a second type of calcium-rich claystone exhibiting irregularly-shaped particles of different sizes. FIG. 3B is an energy dispersive x-ray spectra (EDS) showing the elemental analysis results of the calcium-rich claystone (analyzed at the region noted with the arrow labeled “A” in FIG. 3A) comprising oxygen (40.0 wt. %) having a σ of 0.3; silicon (25.7 wt. %) having a σ of 0.2; calcium (15.3 wt. %) having a σ of 0.1; magnesium (10.1 wt. %) having a σ of 0.1; iron (7.1 wt. %) having a σ of 0.2; aluminum (1.3 wt. %) having a σ of 0.1; and titanium (0.5 wt. %) having a σ of 0.1. FIG. 3C is an energy dispersive x-ray spectra (EDS) showing the elemental analysis results of the calcium-rich claystone (analyzed at the region noted with the arrow labeled “B” in FIG. 3A) comprising oxygen (39.6 wt. %) having a σ of 0.3; silicon (25.7 wt. %) having a σ of 0.2; calcium (15.0 wt. %) having a σ of 0.1; magnesium (9.9 wt. %) having a σ of 0.1; iron (7.6 wt. %) having a σ of 0.2; aluminum (1.0 wt. %) having a σ of 0.1; titanium (0.5 wt. %) having a σ of 0.1; sodium (0.3 wt. %) having a σ of 0.1; and magnesium (0.3 wt. %) having a σ of 0.1.

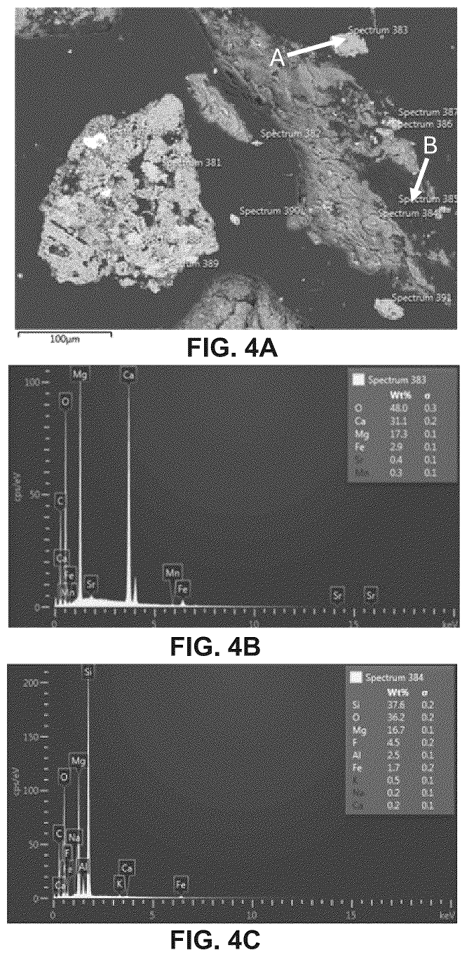

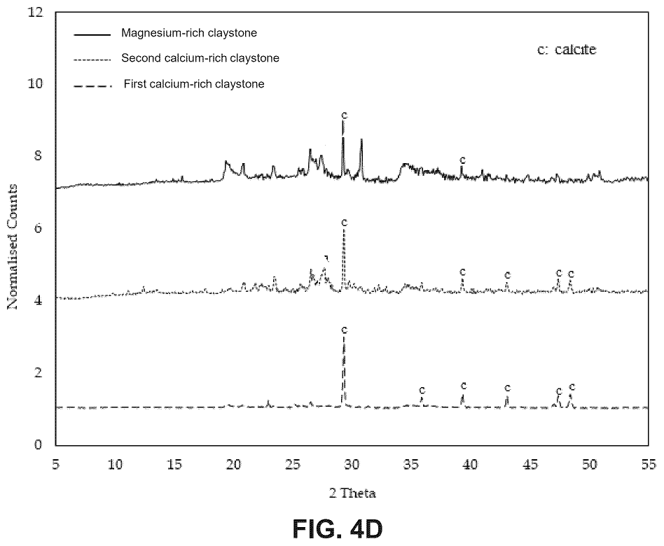

FIG. 4A is an SEM image showing a magnesium-rich claystone comprising larger plate-type aggregates and cavities as compared to the calcium-rich claystones of FIG. 2A and FIG. 3A. FIG. 4C is an energy dispersive x-ray spectra (EDS) showing the elemental analysis results of the calcium-rich claystone (analyzed at the region noted with the arrow labeled “B” in FIG. 4A) comprising silicon (37.6 wt. %) having a σ of 0.2; oxygen (36.2 wt. %) having a σ of 0.2; magnesium (16.7 wt. %) having a σ of 0.1; fluorine (4.5 wt. %) having a σ of 0.2; Al (2.5 wt. %) having a σ of 0.1; iron (1.7 wt. %) having a σ of 0.2; potassium (0.5 wt. %) having a σ of 0.1; sodium (0.2 wt. %) having a σ of 0.1; and calcium (0.2 wt. %) having a σ of 0.1.

FIG. 4D shows the x-ray diffraction (XRD) results obtained from the first and second calcium-rich claystones shown in FIG. 2A and FIG. 3A, respectively, and of the magnesium-rich claystone of FIG. 4A; FIG. 4D demonstrates strong calcite peaks at 20 for all three claystone.

Accordingly, as can be seen in FIGS. 2A and 3A, the calcium-rich claystone samples were characterized by irregularly-shaped particles of different sizes. Whereas, as can be seen in FIG. 4A, the magnesium-rich claystone samples had larger plate-type aggregates and cavities. In view of the elemental analysis (see FIGS. 2B-2C, 3B-3C, 4B-4C), calcium and magnesium were detected in high weight precents along with silica and oxygen. The calcium counts were higher for the calcium-rich samples. While the calcium content was high in the Mg-rich silicate, magnesium was more homogenously dispersed. As can be seen in FIG. 4D, the calcite peaks appear strongest in all the three claystone samples, evidenced by the major peaks at 20 around 29°, indicating that calcium is an impurity that can be removed using a method according to aspects of the present disclosure.

### Example 2

In this example the particle size distribution and elemental composition of the first calcium-rich claystone, second calcium-rich claystone, and magnesium-rich claystone was investigated.

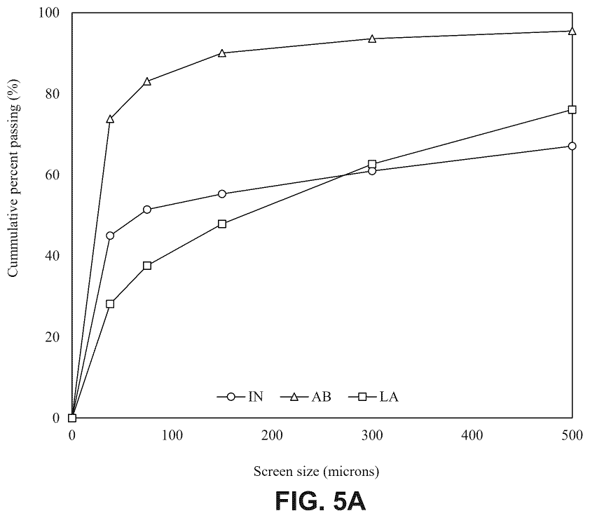

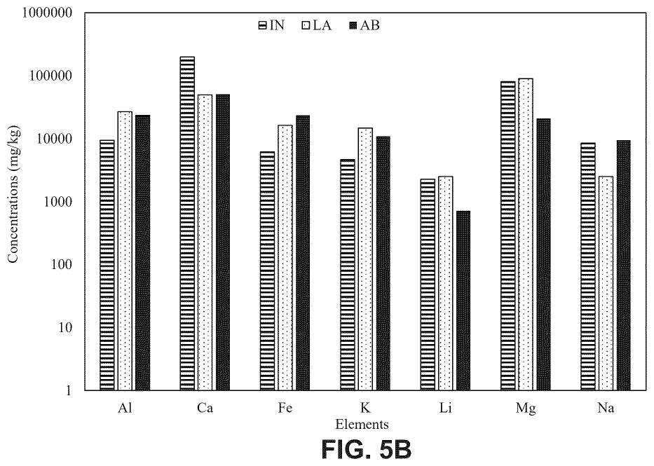

FIG. 5A is a graph of the cumulative percent passing (%) as a function of screen size (microns) showing results obtained after sieving a first calcium-rich claystone (IN), a second calcium-rich claystone (AB), and a magnesium-rich claystone (LA). Accordingly, the d80 size for the first calcium-rich claystone, second calcium-rich claystone, and magnesium-rich claystone was 63 μm, 92 μm, and 56 μm, respectively. Thus, the AB sample had the highest fine-particle content.

The elemental compositions of the different claystone are shown in FIG. 5B, which is a bar graph showing the elemental compositions for the first calcium-rich claystone (IN), second calcium-rich claystone (AB), and the magnesium-rich claystone (LA), and compares the concentration (mg/kg) of Al, Ca, Fe, K, Li, Mg, and Na in the IN sample, LA sample, and AB sample. Table 4 shows the abundance (mg/kg) of Ca, Li, and Mg. Accordingly, the concentration of calcium and magnesium are consistent with the calcite's identification by SEM and SEM-EDS in Example 1.

TABLE 4

| | IN | | LA | | AB | |
|---|---|---|---|---|---|---|
| Element | (Concentration) | | (Concentration) | | (Concentration) | |
| Calcium | 198300.02 | mg/kg | 49528.61 | mg/kg | 50904.91 | mg/kg |
| Lithium | 2266.50 | mg/kg | 2494.90 | mg/kg | 719.17 | mg/kg |
| Magnesium | 80404.30 | mg/kg | 89797.29 | mg/kg | 20952.27 | mg/kg |

### Example 3

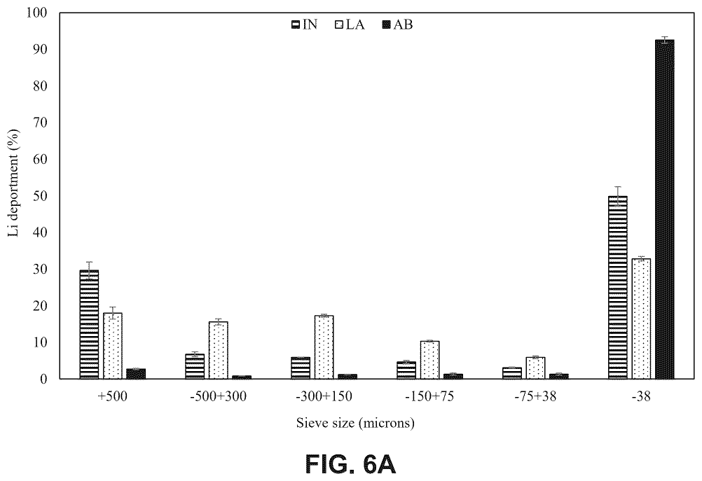

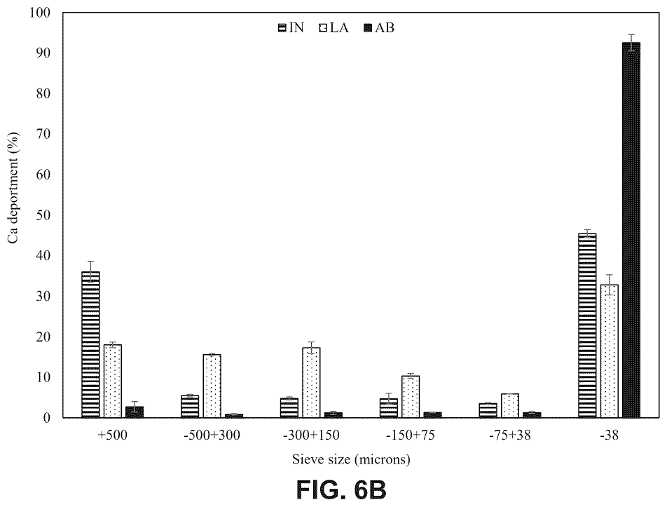

In this example, the deportment of lithium and calcium was investigated. FIG. 6A is a bar graph showing the lithium deportment (%) for a first calcium-rich claystone (IN), a second calcium-rich claystone (AB), a magnesium-rich claystone (LA), which compares the lithium deportment in sieve sizes (μm) of +500, −500+300, −300+150, −150+75, −75+38, and −38. FIG. 6B is a bar graph showing the calcium deportment (%) for a first calcium-rich claystone (IN), a second calcium-rich claystone (AB), and a magnesium-rich claystone (LA), which compares the lithium deportment in sieve sizes (microns) of +500, −500+300, −300+150, −150+75, −75+38, and −38.

In view of FIGS. 6A-6B, the results obtained from the calcium and lithium deportment analysis demonstrates that lithium and calcium were concentrated in the fine fraction for the second calcium-rich claystone (AB); and the distribution of calcium and lithium had a lower concentration in the fine fraction and thus the remaining calcium and lithium was distributed across the coarser particle sizes for the first calcium-rich claystone (IN) and the magnesium-rich claystone (LA).

### Example 4

In view of the results of Example 3, the use of an attrition mill for scrubbing was investigated, particularly for its ability to separate and remove calcium and lithium from granulated material comprising the first calcium-rich claystone (IN), the second calcium-rich claystone (AB), and the magnesium-rich (LA) claystone. The pre-treated feedstock was then introduced into a gravity concentrator to produce a roughing heavies stream, a cleaning lights stream, and a cleaning heavies stream and the lithium and calcium recovery (%) was then investigated for each stream.

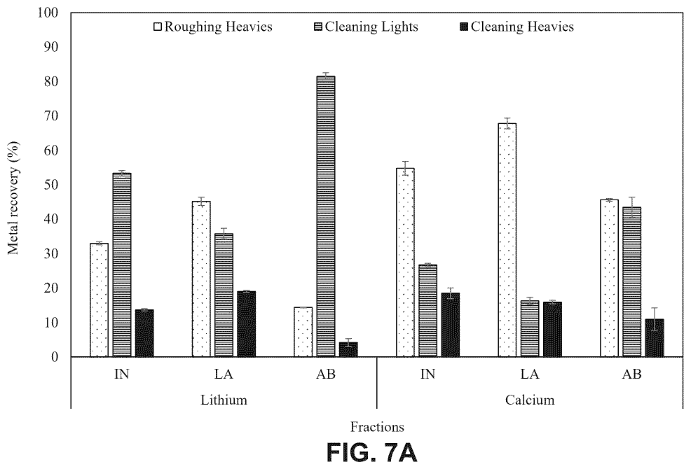

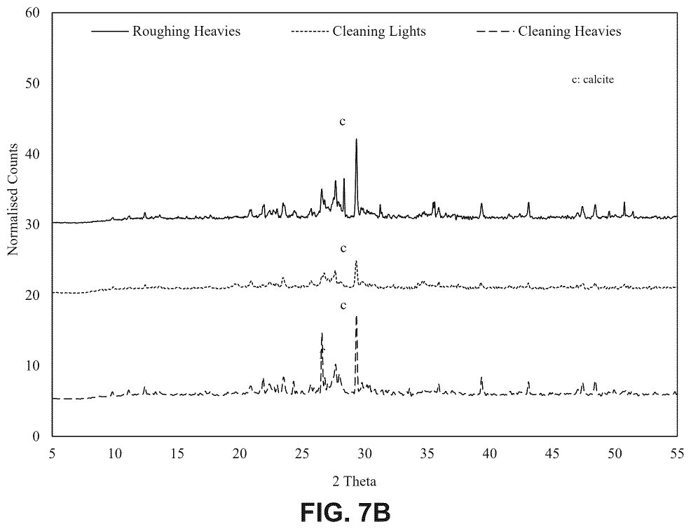

FIG. 7A is a bar graph showing the fractions of lithium and calcium recovery (%) for a first calcium-rich claystone (IN), a second calcium-rich claystone (AB), and a magnesium-rich claystone (LA) in the roughing heavies, cleaning lights, and cleaning heavies, which compares the lithium and calcium recovery (%) using aspects of the method and system disclosed herein. In view of FIG. 7A, a lower amount of lithium was recovered from the first calcium-rich claystone (IN) and magnesium-rich claystone (LA). Nevertheless, there was a desirable amount of calcium removal because the cleaning lights product stream exhibited a low calcium recovery (%) and thus demonstrated the removal of calcium content from the IN and LA feedstock.

Moreover, as shown in FIG. 7A, The AB sample exhibited the greatest lithium recovery, recovering 80.7% of the lithium from AB in the cleaning lights product stream; therefore, the cleaning lights product stream recovered 44% of the calcium from the AB feed and hence a 56% calcium reduction from the AB feed. Furthermore, FIG. 7B shows the XRD results obtained from the roughing heavies, cleaning lights, and cleaning heavies produced from centrifuging a pretreated feedstock obtained with no chemical dispersant from the second-calcium rich claystone (AB) shown in FIG. 3A. FIG. 7B demonstrates a lower calcite peak for the cleaning lights product stream and thus demonstrates the separation of the calcite using aspects of the method and system disclosed herein.

### Example 5

Without being bound to a single theory, a chemical dispersant was added to break up agglomerated coarse clay particles in feedstocks comprising the first calcium-rich claystone (IN), the second calcium-rich claystone (AB), and the magnesium-rich claystone (LA). More specifically, sodium hexametaphosphate was added and investigated for its effect on agglomerated course particles.

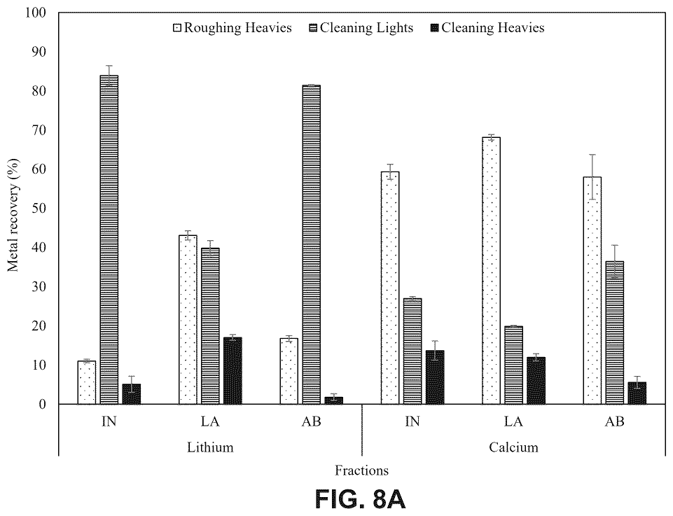

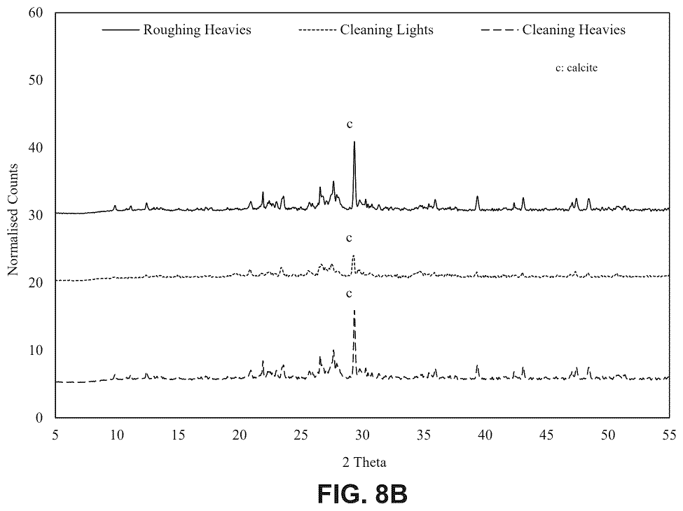

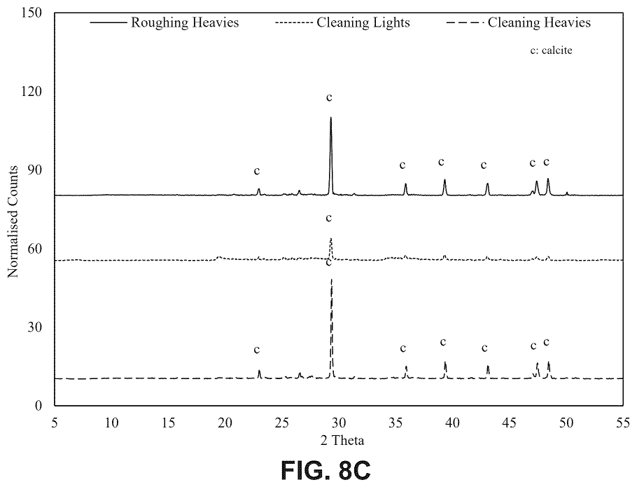

FIG. 8A is a bar graph showing the fractions of lithium and calcium recovery (%) for a first calcium-rich claystone (IN), a second calcium-rich claystone (AB), and a magnesium-rich claystone (LA) in the roughing heavies, cleaning lights, and cleaning heavies, which compares the lithium and calcium recovery (%) using aspects of the method and system disclosed herein with a chemical dispersant. In view of FIG. 8A, the lithium recovery and calcite rejection showed similar results to the results of Example 4 (no chemical dispersant). FIG. 8B shows the XRD results obtained from the roughing heavies, cleaning lights, and cleaning heavies produced from centrifuging a pretreated feedstock obtained with a chemical dispersant from the second calcium-rich claystone (AB) shown in FIG. 3A and demonstrates a lower calcite peak for the cleaning lights product stream.

However, in view of FIG. 8A the cleaning lights product stream produced from the IN feedstock had a greater than 80% lithium recovery and a 27% calcium recovery the separation of calcium and lithium from the IN feedstock increased by adding sodium hexametaphosphate; thus, the addition of a chemical dispersant increased the separation of efficiency from 25% to 53%. Moreover, FIG. 8C shows the XRD results obtained from the roughing heavies, cleaning lights, and cleaning heavies produced from centrifuging a pretreated feedstock obtained with a chemical dispersant from the first calcium-rich claystone (IN) shown in FIG. 2A and demonstrates the cleaning lights product stream having a low calcite peak. Accordingly, without being bound by a particular theory, these results suggest that the lithium-containing particles and the calcium-containing particles may be agglomerated prior to the addition of the chemical dispersant, making them more susceptible to stratification in the light and heavy fractions by fluidizing water and drag force.

### Example 6

In this example, the effect of attrition scrubbing on particle size distribution and gravity concentrator separation for feedstocks comprising the second calcium-rich claystone (AB), and the magnesium-rich claystone (LA) was investigated. First, the feedstocks were pre-treated via attrition scrubbing using an attrition mill to evaluate the effect on improving the separation efficiency by deagglomerating lithium-bearing particles from the calcite particles. The samples treated with attrition scrubbing were then exposed to gravity concentrator separation.

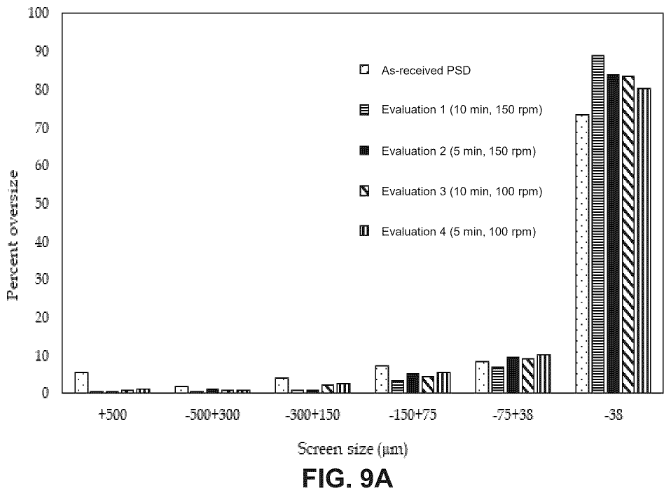

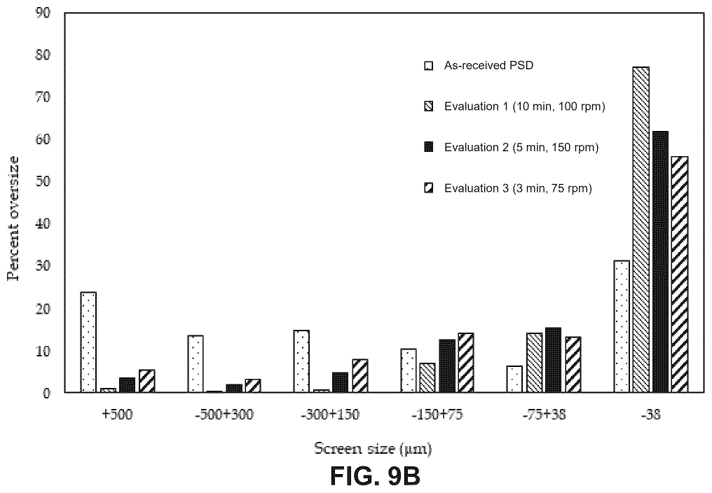

Particle size distribution after attrition at varied scrubbing time and speed are shown in FIGS. 9A-9B. FIG. 9A is a bar graph showing the particle size distribution after attrition of the of a second calcium-rich claystone (AB), which compares the percent oversize for (i) an “as-received” particle size distribution (PSD), (ii) Evaluation 1 (10 minutes, 150 rpm), (iii) Evaluation 2 (5 minutes, 50 rpm), (iv) Evaluation 3 (10 minutes, 100 rpm), and (v) Evaluation 4 (5 minutes, 100 rpm) at screen sizes (μm) of +500, −500+300, −300+150, −150+175, −75+38, and −38 using aspects of the method and system disclosed herein wherein attrition scrubbing was performed.

FIG. 9B is a bar graph showing the particle size distribution after attrition of a magnesium-rich claystone (LA), which compares the percent oversize for an (i) as-received PSD, Evaluation 1 (10 minutes, 100 rpm), Evaluation 2 (5 minutes, 150 rpm), and Evaluation 3 (3 minutes, 75 rpm) at screen sizes (μm) of +500, −500+300, −300+150, −150+175, −75+38, and −38 using aspects of the method and system disclosed herein wherein attrition scrubbing was performed.

According to results shown in FIG. 9A, the attrition speed of 100 rpm for 10 minutes reduced the distribution of the particles in the coarse fraction and thus closely distributed in the fine fraction. As shown in FIG. 9B, the attrition scrubbing on the LA sample reduced the coarse particle size and therefore increased the components reporting into the fine fraction.

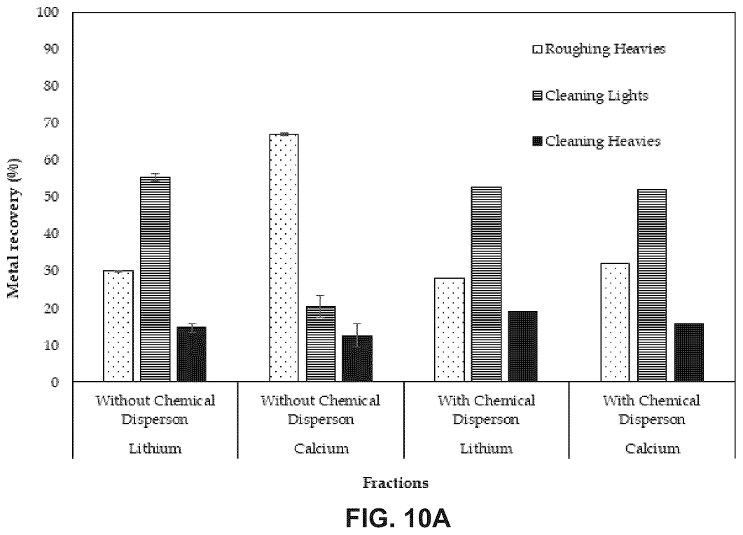

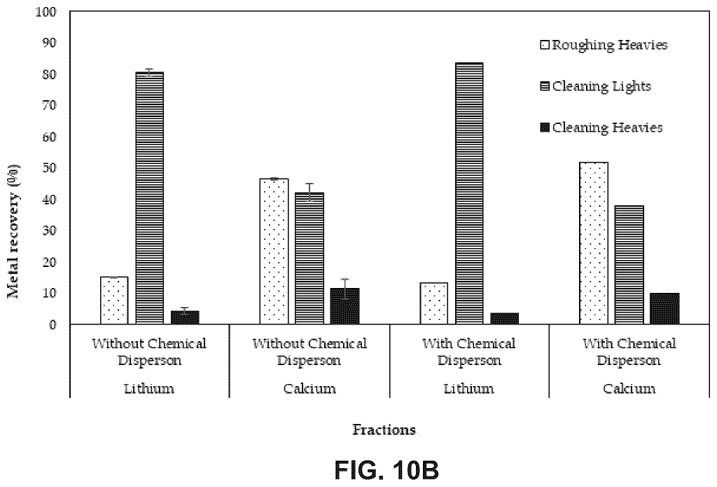

The pre-treated feedstocks were then introduced into the gravity concentrator and the results are shown in FIGS. 10A-10B. FIG. 10A is a bar graph showing the fractions of lithium and calcium recovery (%) for a magnesium-rich claystone (LA) in the roughing heavies, cleaning lights, and cleaning heavies, which compares the lithium and calcium recovery (%) using aspects of the method and system disclosed herein (i) with no chemical dispersant and (ii) with chemical dispersant. FIG. 10B is a bar graph showing the fractions of lithium and calcium recovery (%) for the second calcium-rich claystone (LA) in the roughing heavies, cleaning lights, and cleaning heavies, which compares the lithium and calcium recovery (%) using aspects of the method and system disclosed herein (i) with no chemical dispersant and (ii) with chemical dispersant.

TABLE 5

| Attrition | Recovery in the Cleaning | Without | With |
|---|---|---|---|
| Scrubbing | Light Product Stream | Dispersant | Dispersant |
| Yes | Lithium | 79% | 83% |
| | Calcium | 30% | 34% |
| No | Lithium | 80% | 84% |
| | Calcium | 41% | 38% |

TABLE 6

| Attrition | Recovery in the Cleaning | Without | With |
|---|---|---|---|
| Scrubbing | Light Product Stream | dispersant | dispersant |
| Yes | Lithium | 55% | 53% |
| | Calcium | 20% | 23% |
| No | Lithium | 36% | 40% |
| | Calcium | 16% | 20% |

Results in FIG. 10A and Table 5 indicate that attrition scrubbing increased the lithium recovery from 78% without a chemical dispersant to 83% with a chemical dispersant from the AB claystone. Furthermore, the recovery of calcium in the cleaning lights product stream using attrition scrubbing was 30% without the chemical dispersant and 34% without dispersant, whereas the calcium removal without attrition was 41% without a chemical dispersant and 38% with a chemical dispersant. The separation efficiency is another way to examine the efficacy in a combined separation process (i.e., the difference between the lithium recovery and calcium recovery in the cleaning lights product stream). In some aspects, the highest separation efficiency demonstrated for the AB claystone was 49%, which was achieved with attrition scrubbing and a chemical dispersant.

Results in FIG. 10B and Table 6 indicate that lithium recovery with attrition scrubbing increased by nearly 20% with the use of the chemical dispersant for the LA claystone. The calcium removal in the cleaning lights product stream was 80% (20% calcium recovery in the cleaning lights product stream). The separation efficiency for the LA claystone with attrition scrubbing was 35% without the chemical dispersant and 30% with the chemical dispersant, whereas no attrition scrubbing resulted in a separation efficiency of 20%.

Accordingly, this example demonstrates pre-treating the feedstock claystone using attrition scrubbing prior to separation via the gravity concentrator can facilitate improved lithium recovery and calcium removal.

### Example 7

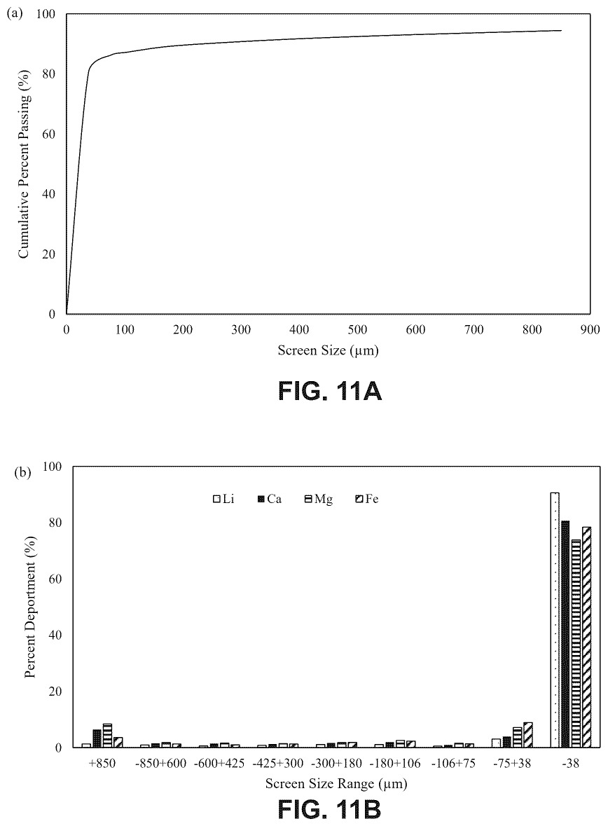

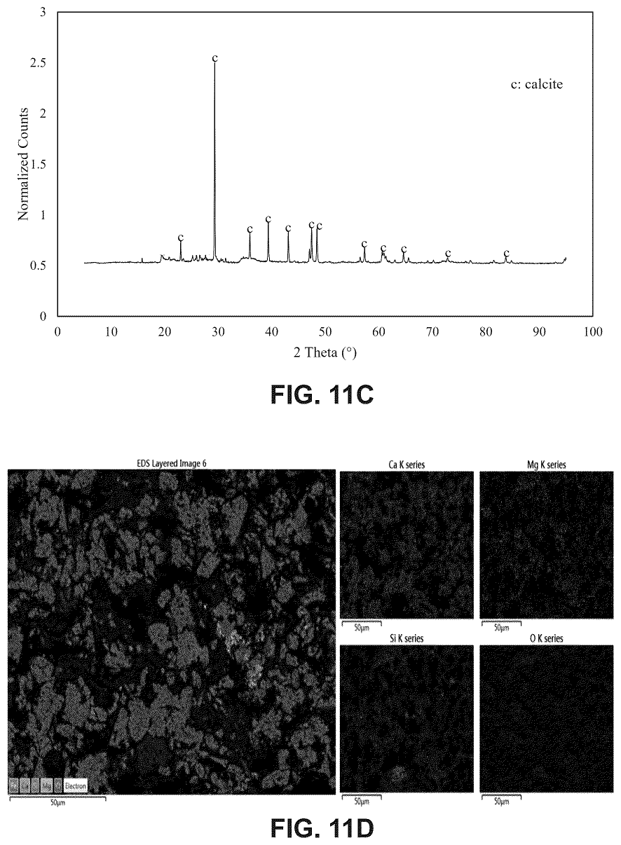

In this example, leaching evaluations were carried out on a lithium-containing claystone after having been subjected to a method according to the present disclosure. In this example, the Falcon gravity concentrator was used to upgrade the lithium-containing claystone prior to a leaching step. The efficiency of leaching on the overall lithium recovery was investigated on the clay samples pretreated by gravity concentration as well as those without any pretreatment, i.e., direct leaching without employing a method according to the present disclosure. The particle size distribution of the claystone sample is shown in FIG. 11A. The d₈₀ was determined to be about 38 μm, indicative of the fine nature of the claystone. The distribution of the desired metal species in the sample, lithium, calcium, magnesium, and iron, at various particle size ranges were also evaluated and the results are presented in FIG. 11B. Accordingly, the majority of the elemental species were enriched in the fine particle size fraction of the sample (less than 38 μm), while minimal amounts were scattered in the remaining size fractions. The elemental composition of the lithium-containing claystone from ICP-OES analysis is presented in Table 7.

TABLE 7

| Element | Al | Ca | Fe | K | Li | Mg | Na |
|---|---|---|---|---|---|---|---|
| Concentration (ppm) | 9312.72 | 199094.2 | 5889.46 | 23515.38 | 3391.38 | 90503.13 | 4398.21 |

The lithium content is about 0.34%, while calcium, the major impurity in this lithium-containing claystone, is present at about 19.9%. The lithium-containing claystone also contains high amounts of magnesium, potassium, and aluminum. The mineralogical composition of the lithium-containing claystone was determined by XRD analysis, and the major minerals present are shown in FIG. 11C. FIG. 11C demonstrates a prominent peak at 2 θ around 29°, which indicates calcite as being the predominant mineral present in the lithium-containing claystone. Given that calcium is a polymorph of calcium carbonate, the observation made with the XRD is consistent with that of the elemental analysis and confirms that calcium is the major impurity. In addition, the morphology and composition of the lithium-containing claystone was investigated and presented in FIG. 11D. The lithium-containing claystone was characterized by fine, irregularly shaped particles with some degree of clustering, indicating some degree of agglomeration. The corresponding EDS spectrum indicates high counts of calcium, silicon, oxygen, and magnesium at 30.6 wt. %, 17.6 wt. %, 40.2 wt. %, and 9.6 wt. %. The Mg—Si—O associations indicate that the sample is a magnesium-rich silicate.

### Example 8

In the example, preliminary separation experiments were performed with a Falcon concentrator to remove gangue calcite minerals and thus upgrade the lithium concentrations. The effects of various pretreatment parameters, such as attrition scrubbing and chemical dispersion, on the separation efficiencies of the falcon with the lithium-containing claystone were investigated. The separation efficiency under the various evaluation conditions was investigated based on lithium and calcium recoveries, with lithium considered as the desired component and calcium is a proxy for calcite as the gangue mineral. Gravity separators are used to recover valuable minerals by concentrating them in the heavy fraction, leaving gangue minerals in the light fraction; however, this example employs the reverse approach. Lithium is predominantly concentrated in the light stream due to its mineralogical association with clays, while calcite and other gangue minerals accumulate in the heavy stream. Therefore, the light fraction after two-stage Falcon separation was considered as the target stream, and the recoveries of relevant elements into this stream are reported. Magnesium recovery was closely monitored, given that the lithium-containing claystone is a magnesium-rich silicate.

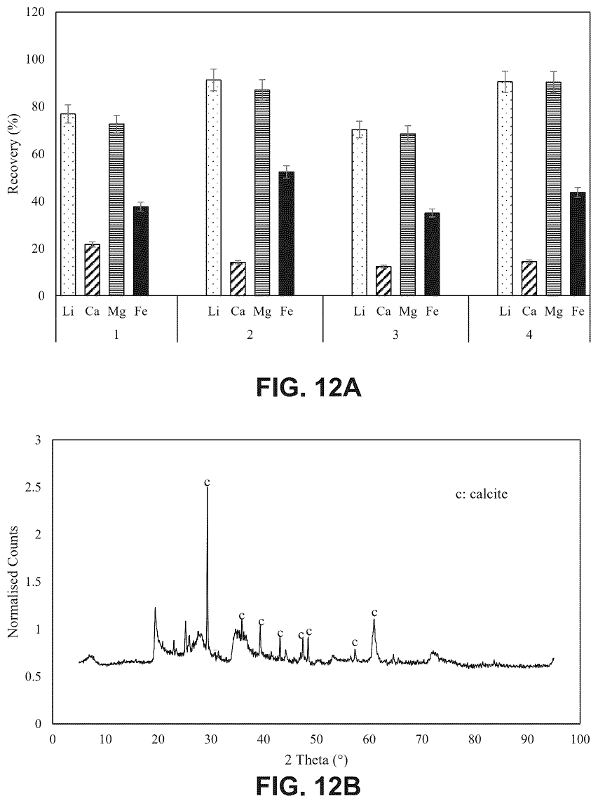

The lithium, calcium, magnesium, and iron recoveries in the light stream is shown in FIG. 12A. In the separation evaluation without pretreatment (Evaluation 1), lithium recovery was approximately 77%, while calcium recovery was about 22%, giving a separation efficiency of around 55% between these two elements, as indicated in Table 8. The efficiency improved to about 77% with chemical dispersion, achieving optimal lithium and calcium recoveries of 91% and 14%, respectively. The morphological analysis of the lithium-containing claystone hinted at some degree of agglomeration, which negatively impacts separation. Dispersion with sodium hexametaphosphate (SHMP) increased the electrical double layer thickness, breaking up particle clusters by substituting sodium cations to boost the overall negative surface charge along particle interaction edges. The resulting dispersed particles were more uniformly distributed, allowing better separation due to enhanced particle interaction with induced forces during Falcon operation. In Evaluation 3, which used only attrition scrubbing, a separation efficiency of approximately 58% was demonstrated, slightly higher than the evaluation without pretreatment.

Lithium and calcium recoveries were 70% and 12%, respectively, indicating that attrition scrubbing positively impacts calcium removal. When attrition scrubbing was combined with chemical dispersion in Evaluation 4, separation efficiency improved to about 76%, with elemental recoveries similar to those in Evaluation 2. The pretreatment used in Evaluation 2 achieved the highest separation efficiency, demonstrating the lithium-containing claystone's amenability to this approach. Additionally, eliminating the need for attrition scrubbing further supports this choice in economic terms for certain aspects. XRD analysis was conducted on the fine fraction after separation to confirm the findings for calcite removal. Compared to the XRD analysis of the original feed lithium-containing claystone, the calcite peak was sufficiently reduced, indicating its removal. This further demonstrates the efficiency of aspects of the disclosed method to remove calcite while upgrading lithium.

TABLE 8

| Evaluation | Evaluation Pretreatment | Separation |
|---|---|---|
| Number | Condition | Efficiency (%) |
| 1 | No pretreatment | 55.17 |
| 2 | Chemical dispersion only | 77.11 |
| 3 | Attrition scrubbing only | 57.97 |
| 4 | Attrition scrubbing and chemical dispersion | 76.09 |

To evaluate the removal of calcite, the primary carbonate mineral, carbon analysis was performed to compare the carbonate content of the untreated lithium-containing claystone and the light fraction material after Falcon separation using a method according to the present disclosure. As shown in Table 9, the fines from separation contained 7.55% carbonates, while that in the untreated lithium-containing claystone was 18.54%, translating to 185.4 kg of carbonates per ton of claystone.

TABLE 9

| Material | CO₂ (%) | Carbonates (%) | Carbonates (kg/ton) |
|---|---|---|---|
| Untreated Feed | 13.60 | 18.54 | 185.4 |
| Falcon Fine Fraction | 5.54 | 7.55 | 75.5 |

This represents a difference of about 109.9 kg per ton of carbonates, which means in terms of recovery, about 79% of the carbonates was effectively removed after Falcon separation. Comparing with the calcium rejected as an indicator for removal of calcite, the remaining difference suggests that a portion of the calcium removed could be associated with the silicate minerals present like clinoptilolite as identified in the X-ray diffraction analysis, as these calcium-bearing silicate minerals are not entirely amenable to this gravity separation technique.

### Example 9

The results of the 30-run CCD experiments are presented in Table 10, with four variables: acid concentration (A), leaching temperature (B), time (C), and solid-liquid ratio (D) chosen for increased lithium extraction and the diminution of recoveries of selected gangue species.

TABLE 10

| | | Li | Mg | Ca | Fe |
|---|---|---|---|---|---|
| Standard | | Recovery | Recovery | Recovery | Recovery |
| Order | Run | (%) | (%) | (%) | (%) |
| 9 | 1 | 7.53 | 8.34 | 10.3 | 4.24 |
| 19 | 2 | 79.22 | 58.56 | 9.12 | 3.01 |
| 18 | 3 | 91.11 | 66.09 | 9.98 | 4.41 |
| 6 | 4 | 100.00 | 94.76 | 15.42 | 11.63 |
| 8 | 5 | 100.00 | 96.48 | 20.56 | 33.35 |
| 16 | 6 | 77.36 | 61.38 | 6.52 | 4.49 |
| 14 | 7 | 84.45 | 66.04 | 5.29 | 0.89 |
| 12 | 8 | 80.34 | 55.71 | 7.51 | 5.26 |
| 4 | 9 | 100.00 | 96.95 | 20.03 | 35.04 |
| 5 | 10 | 76.72 | 67.97 | 12.74 | 0.67 |
| 2 | 11 | 93.90 | 80.18 | 15.54 | 22.44 |
| 20 | 12 | 83.67 | 68.36 | 9.15 | 2.65 |
| 11 | 13 | 17.73 | 13.82 | 11.66 | 0.3 |
| 13 | 14 | 5.85 | 6.68 | 6.25 | 0.54 |
| 15 | 15 | 11.24 | 5.75 | 5.56 | 0.08 |
| 7 | 16 | 72.42 | 59.49 | 15.01 | 4.08 |
| 10 | 17 | 79.67 | 65.32 | 5.52 | 8.63 |
| 1 | 18 | 51.92 | 47.85 | 15.42 | 7.92 |
| 3 | 19 | 66.88 | 58.18 | 15.84 | 4.51 |
| 17 | 20 | 80.11 | 59.78 | 9.15 | 3.98 |
| 29 | 21 | 81.13 | 60.69 | 9.03 | 6.84 |
| 24 | 22 | 82.48 | 61.05 | 9.1 | 1.86 |
| 30 | 23 | 79.55 | 66.57 | 8.12 | 6.41 |
| 22 | 24 | 99.16 | 74.52 | 8.72 | 25.32 |
| 27 | 25 | 93.34 | 84.68 | 16.57 | 23.24 |
| 21 | 26 | 19.68 | 17.74 | 8.1 | 8.52 |
| 23 | 27 | 76.32 | 58.75 | 6.64 | 0.38 |
| 25 | 28 | 77.01 | 59.87 | 9.35 | 4.4 |
| 28 | 29 | 42.54 | 35.51 | 6.87 | 7.34 |
| 26 | 30 | 87.37 | 63.55 | 9.28 | 0.98 |

The predicted model equations which establish a relationship between the leaching parameters and recoveries of lithium, magnesium, calcium, and iron are given by Equations 5, 6, 7, and 8, respectively, where the negative signs indicate opposing effects and the positive signs indicate the synergistic effects of those parameters.

$$Lithium recovery ( \% ) = - 19.3 + 167.6 A - 0.057 B + 0.86 C + 0.44 D - 70. {A}^{2} + 0.00396 {B}^{2} + 0.374 {C}^{2} + 0.0898 {D}^{2} - 0.08 A * B - 0.318 A * C + 1.702 A * D - 0.0267 B * C - 0.00452 B * D - 0.0793 C * D \qquad Equation 5$$

$$Magnesium recovery ( \% ) = 14.6 + 1 28.2 A + 0.1 \; 45 B + 1.24 C - 2.75 D - 51.8 {A}^{2} + 0.0013 {B}^{2} + 0.1 \; 87 {C}^{2} + 0.0102 {D}^{2} - 0.0 \; 11 A * B + 0.293 A * C + 0.987 A * D - 0.0235 B * C - 0.0 \; 0751 B * D - 0.0648 C * D \qquad Equation 6$$

$$Calcium recovery ( \% ) = 19.37 + 3.78 A + 0.1 \; 843 B - 0.725 C - 1.216 D - 1.19 {A}^{2} - 0.001338 {B}^{2} + 0.0433 {C}^{2} + 0.03014 {D}^{2} + 0.0474 A * B + 0.4283 A * C + 0.2684 A * D - 0.00021 B * C - 0.002107 B * D - 0.01378 C * D \qquad Equation 7$$

$$Iron recovery ( \% ) = 19.81 - 53.2 A + 1.134 B + 1.52 C - 2.329 D + 37.27 {A}^{2} - 0.01037 {B}^{2} - 0.349 {C}^{2} + 0.0769 {D}^{2} + 0.1948 A * B - 0.314 A * C - 0.89 A * D + 0.01759 B * C - 0.0 \; 0962 B * D + 0.0129 C * D \qquad Equation 8$$

Regression analysis and ANOVA were used to fit the model and examine the statistical significance of the terms. Table 11 summarizes the analysis of variance results for this model along with the corresponding coefficients of determination (R²) and adjusted R² estimated to check the model adequacy and give the proportion of the total variation in the response predicted by the model.

TABLE 11

| Response | F-value | p-value | R² | Adj. R² |
|---|---|---|---|---|
| Li Recovery (%) | 37.06 | <0.0001 | 0.9754 | 0.9491 |
| Mg Recovery (%) | 38.69 | <0.0001 | 0.9764 | 0.9512 |
| Ca Recovery (%) | 64.79 | <0.0001 | 0.9858 | 0.9706 |
| Fe Recovery (%) | 30.37 | <0.0001 | 0.9702 | 0.9382 |

From Table 11, the R² values of the individual models show well-fitted models and their appropriateness to explain the relation between the variables. The significance test was conducted at a 95% confidence level using p-values, with statistical significance defined as p less than 0.05. The regression model's p-value (<0.0001) indicates its adequacy at this confidence level. The F-test also evaluated the significance of each parameter within the regression equation. The lack of fit had p-values greater than 0.05, implying that the selected variables produce a sufficiently accurate model for predicting relevant responses. Table 11 confirms the model's high significance with an F-value of 37.06 and a p-value below 0.0001, validating the reduced quadratic model's accuracy for lithium leaching and recovery predictions. Similar observations were made with calcium, magnesium, and iron.

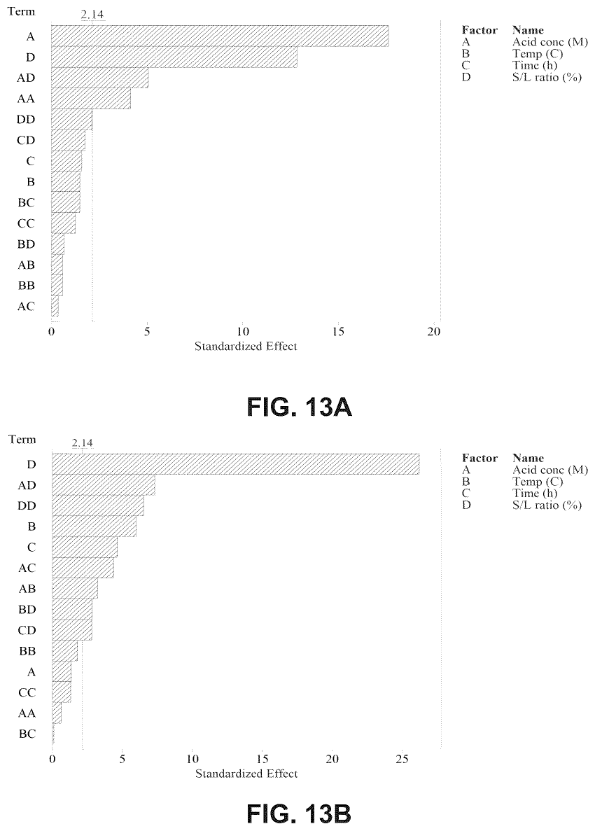

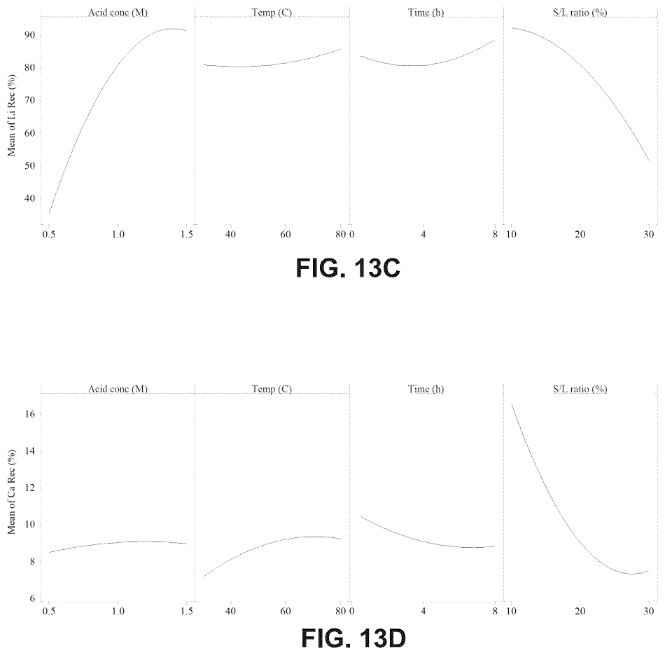

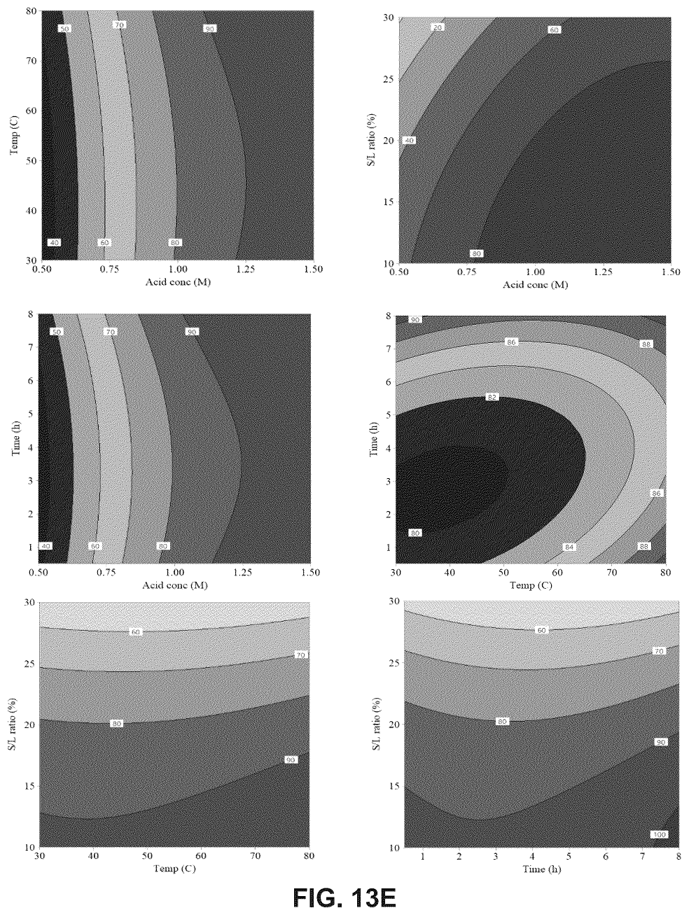

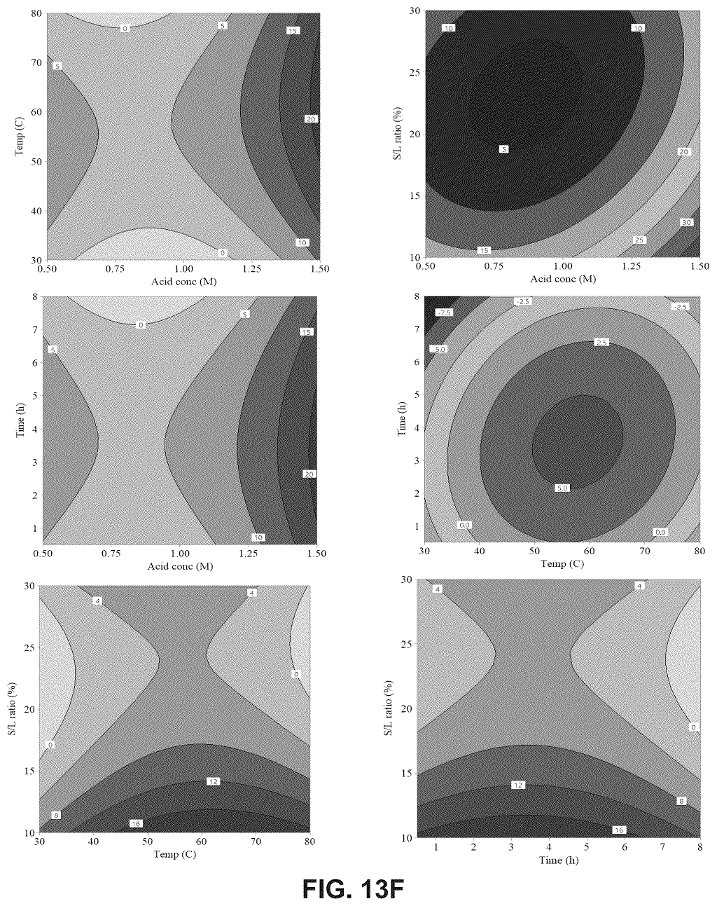

The Pareto charts illustrated in FIGS. 13A-13B demonstrate the factors that involved in the leaching experiments for lithium and calcium recoveries. The acid concentration and solid-liquid ratio of the leach pulp were observed as the parameters associated with suitable lithium recovery. The leaching temperature and time were not in the 95% confidence interval and therefore had a minimal impact on the recovery of lithium. For calcium, the leaching recovery was largely unaffected by the acid concentration but impacted by the other parameters such as solid content.

The individual effects of the studied leaching parameters on lithium and calcium are demonstrated in FIGS. 13C-13D. The one factorial plot provides the singular impact of the leach parameters while assuming all other factors are constant. Accordingly, the lithium recovery was greater by increasing the acid concentration but decreased with increasing solids concentrations. The leaching temperature and time on lithium recovery of the claystone sample led to increase in lithium recoveries. Similar effect was observed with calcium except for increasing acid concentrations which had a low impact on the recovery as observed in the calcium recovery model.

To further investigate the model, contour plots were used to investigate the main and interactive effects of two independent factors, while other parameters were held constant at their central levels. FIG. 13E shows the contour plot of Li recovery (%) representing combined interactions of acid concentration and leaching temperature (top left image); leaching temperature and time (top right image); acid concentration and time (middle left image); leaching temperature and solid-liquid ratio (middle right image); acid concentration and solid-liquid ratio (bottom left image); and time and solid-liquid ratio (bottom right image). The plots shown in the top left image and middle left image show the interaction of acid concentration with leaching temperature, and time respectively on lithium recovery. At higher acid concentrations, lithium recoveries increased with minimal influence by temperature and time. In addition, as demonstrated in the plot shown in the top right image, the contour of solid-liquid ratio and acid concentration is elliptic, and therefore their interaction is desirable. Thus, at lower solids concentrations and high acid concentrations, lithium recoveries increased. The plot shown in the middle right image demonstrates that the interaction between time and leaching temperature where the center of the ellipse concentrically yields lower lithium recoveries. The horizontally layered contours shown in bottom left and bottom right images indicate that the solid-liquid ratio affected the lithium recovery to a higher extent as compared to leaching temperature and time. The observations made are consistent with those made with the factorial plots and Pareto charts, indicating that acid concentration and solid-liquid ratio are the parameters that affecting a desirable lithium recovery.

FIG. 13F shows plots of Ca Recovery (%) representing combined interactions of acid concentration and leaching temperature (top left image); acid concentration and solid-liquid ratio (top right image); acid concentration and time (middle left image); leaching temperature and time (middle right image); leaching temperature and solid-liquid ratio (bottom left image); and time and solid-liquid ratio (bottom right image). For calcium recoveries, acid concentration demonstrated a less desirable effect while the solid-liquid ratio had the most desirable effect on calcium recovery.

### Example 10

In this example, lithium and magnesium recovery responses were maximized while those of calcium and iron were set to a minimum. Based on the regression model, the conditions that can achieve desirable leaching conditions were determined and presented in Table 11. Evaluations were carried out in the laboratory to investigate the combinations of the process variables generated by the model. The comparison between the experimental and the predicted elemental recoveries are shown in Table 12, which indicates the errors were less than 5%. As such, the developed model demonstrates desirable recoveries of the metals.

TABLE 11
Responses

| | Acid | | | S/L | | | | | |
|---|---|---|---|---|---|---|---|---|---|
| | Conc | Temp. | Time | Ratio | Li Rec | Ca Rec | Mg Rec | Fe Rec | |
| Run | (M) | (° C.) | (hr) | (%) | (%) | (%) | (%) | (%) | Desirability |
| 1 | 1.47 | 30 | 8 | 24.14 | 94.8669 | 5.2320 | 72.5505 | −1.7147 | 0.9248 |
| 2 | 1.36 | 80 | 8 | 26.21 | 85.8920 | 7.1089 | 62.8267 | 2.1921 | 0.8258 |
| 5 | 1.31 | 80 | 1.93 | 25.83 | 86.4500 | 7.8120 | 63.2754 | 4.3405 | 0.8041 |
| 7 | 1.19 | 30 | 3.60 | 13.55 | 94.9687 | 11.1707 | 79.0071 | 7.5058 | 0.7900 |
| 8 | 1.11 | 30 | 3.94 | 12.72 | 93.6302 | 11.7990 | 79.0451 | 6.3313 | 0.7897 |

TABLE 12

| | | Predicted | Experimental | |
|---|---|---|---|---|
| Element | Selected Run | Recovery (%) | Recovery (%) | Error (%) |
| Li | 2 | 85.89 | 87.96 | 2.36 |
| | 5 | 86.45 | 89.18 | 3.06 |
| Ca | 2 | 7.11 | 7.02 | 1.26 |
| | 5 | 7.81 | 8.17 | 4.37 |
| Mg | 2 | 62.83 | 62.71 | 0.19 |
| | 5 | 63.28 | 63.14 | 0.22 |
| Fe | 2 | 2.19 | 2.23 | 1.81 |
| | 5 | 4.34 | 4.16 | 4.23 |

### Example 11

In this example, the reagent consumption of the claystone during the leaching process was investigated by performing acid consumption evaluations to evaluate the amount of sulfuric acid consumed by the upgraded clay sample as well as the raw sample. Conditions were generated from run 5 as shown above in Table 11 (feed mass of about 13 g, leaching temperature of 80° C., time of 115 minutes, and H₂SO₄ concentration of 1.3 M) was used to leach both the falcon fines and the untreated claystone. Table 13 demonstrates that the separation technique yielded about 30 kg of acid savings per ton of material treated, underlying the efficiency of the separation technique in removing the carbonate gangue.

The reaction between calcite and sulfuric acid during leaching is shown in Equation 9.

Calcite: H₂SO_{4(aq)}+CaCO₃₍ₛ₎→CaSO_{4(aq)}+H₂O_{(I)}+CO_{2(g)} Equation 9

The reaction is accompanied by the release of pure carbon dioxide, which directly contradicts the purpose of producing lithium for clean energy production. For a gram of lithium leached, the untreated feed requires 105.92 g, while the fines from the separation consume only 23.49 g of H₂SO₄. The marked difference in acid requirements to leach lithium further confirms the efficiency of the separation technique and its positive impact on leaching. Furthermore, leaching at these conditions, the fines from the Falcon separation yield about 3800 ppm lithium while that of the untreated claystone recovered 916 ppm lithium, translating to about 1.12 and 0.27 metal upgrades, respectively.

TABLE 13

| | Experimental acid | Acid consumed |
|---|---|---|
| Materials | consumed by ore (kg/ton) | (g/g of Li) |
| Untreated Feed | 375.52 | 105.92 |
| Falcon Fine Fraction | 345.03 | 23.49 |

### Example 12

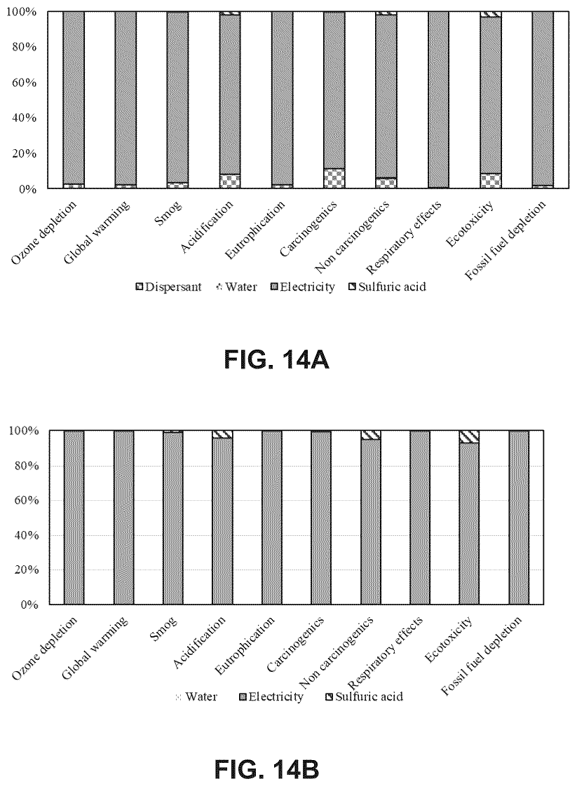

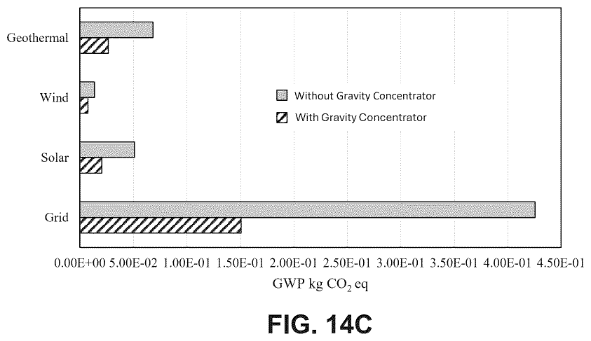

In this example, the life cycle assessment framework was investigated to evaluate the aggregated environmental implications of the lithium extraction process, comparing the environmental footprint of the extraction with the use of a Falcon concentrator to upgrade the lithium-containing claystone prior to a leaching step and without the use of a gravity concentrator. The comprehensive contribution of all the input materials and energy across the different scenarios in the lithium extraction process for 1 g of lithium leached is demonstrated in FIGS. 14A-14B.

FIG. 14A is a bar graph showing the normalized impact assessment for lithium extractions by using a Falcon concentrator to upgrade the lithium-containing claystone prior to a leaching step according to aspects of the method and system described herein. FIG. 14B is a bar graph showing the normalized impact assessment for lithium extractions without using a Falcon concentrator to upgrade the lithium-containing claystone prior to a leaching step. In view of FIGS. 14A-14B, the extraction process with the use of a Falcon concentration to upgrade the lithium-containing claystone prior to leaching has lower environmental consequences. In some categories, such as acidification, carcinogenic, non-carcinogenic, and ecotoxicity, the process using the Falcon concentrator has lower impacts. In terms of global warming potential, there is a total of 1.51E-01 kg CO_{2eq} emission per gram of lithium leached compared with the direct leaching, which records 4.26E-01 kg CO_{2eq} of emission. Accordingly, the leaching process using a Falcon concentrator to upgrade the lithium-containing claystone prior to a leaching step according to aspects of the method of the present disclosure had a more desirable grade and recoverability of lithium as well as ejecting calcite.

The total global warming potential of both scenarios under different energy sources is shown in FIG. 14C, which is a bar graph showing the global warming potential of the lithium extraction routes using different energy sources. Comparatively, the impact of the extraction route that include using a Falcon concentrator to upgrade the lithium-containing claystone prior to a leaching step and use wind energy is only 5.04% of the grid energy while that of the solar and geothermal sources are 13.6% and 17.7%, respectively.

This example explored the environmental impacts of the extraction processes when the electricity was sourced from 100% green sources. Comparatively, wind energy sources had the least impact, reducing the footprint by an average of 96%, which, when employed, will increase the environmental friendliness of the extraction process. As such, this example demonstrates that the method of the present disclosure can be used to improve lithium recovery, particularly if performed prior to a leaching method.

In view of the many possible aspects to which the principles of the present disclosure may be applied, it should be recognized that the illustrated aspects are only preferred examples of the present disclosure and should not be taken as limiting the scope of the present disclosure. Rather, the scope of the disclosure is defined by the following claims. We therefore claim as our invention all that comes within the scope and spirit of these claims.

We claim:

1. A method for removing one or more calcium compounds from a lithium-containing claystone, the method comprising:
homogenizing a granulated material comprising the lithium-containing claystone;
obtaining a pre-treated feedstock from the granulated material using a separating apparatus;
feeding the pre-treated feedstock into a gravity concentrator; and
centrifuging the pre-treated feedstock to form a calcium material-concentrated layer and a lithium material-concentrated layer.

2. The method of claim 1, wherein the lithium-containing claystone comprises a mixture of one or more lithium compounds and the one or more calcium compounds.

3. The method of claim 2, wherein the one or more lithium compounds have an average particle size that is smaller than an average particle size of the one or more calcium compounds.

4. The method of claim 1, wherein the lithium-containing claystone further comprises aluminum compounds, iron compounds, potassium compounds, magnesium compounds, sodium compounds, or any combination thereof.

5. The method of claim 1, wherein homogenizing the granulated material comprising the lithium-containing claystone comprises using a mixer to homogenize the granulated material.

6. The method of claim 1, wherein the separating apparatus is a sieve comprising one or more screens having a plurality of openings, wherein each opening of the plurality of openings has a size ranging from 20 μm to 1000 μm and the method further comprises wet screening with the sieve.

7. The method of claim 1, wherein the separating apparatus is an agitator and the method further comprises attrition scrubbing the granulated material.

8. The method of claim 1, further comprising mixing a chemical dispersant with the granulated material prior to obtain the pre-treated feedstock.

9. The method of claim 8, wherein the chemical dispersant is added in an amount ranging from 5 to 50 grams per kilogram of lithium-containing claystone.

10. The method of claim 8, wherein the chemical dispersant is a sodium polyphosphate, a tannin, a sodium polymethacrylate, or any combination thereof.

11. The method of claim 10, wherein the sodium polyphosphate is sodium hexametaphosphate and/or wherein the tannin is oak tannin.

12. The method of claim 1, wherein the gravity concentrator is a flowing film concentrator.

13. The method of claim 12, wherein the flowing film concentrator is a centrifugal separator or a multi-gravity separator.

14. The method of claim 1, wherein the centrifuging the pre-treated feedstock comprises subjecting the pre-treated feedstock to a gravitational force ranging from 50 G to 600 G.

15. A method for removing one or more calcium compounds from a lithium-containing claystone, the method comprising:
feeding the lithium-containing claystone into a separating apparatus, wherein the lithium-containing claystone has a calcium concentration ranging from greater than 10,000 mg/kg to 1,000,000 mg/kg;
wet screening using the sieve to obtain a pre-treated feedstock from the lithium-containing claystone;
subjecting the pre-treated feedstock to a centrifugal force using a gravity concentrator; and
producing a calcium material-concentrated layer having one or more calcium compounds in an amount ranging from 50 wt. % to 90 wt. %; and a lithium material-concentrated layer having one or more lithium compounds in an amount ranging from 50 wt. % to 90 wt. %.

16. A system for removing one or more calcium compounds from a lithium-containing claystone, the system comprising:
a separating apparatus; and
a means for separating one or more calcium compounds from one or more lithium compounds present in the lithium-containing claystone, wherein the separating is based on a difference of a specific gravity of the one or more calcium compounds and a specific gravity of the one or more lithium compounds.

17. The system of claim 16, wherein the separating apparatus is a sieve comprising one or more screens having a plurality of openings, wherein each opening of the plurality of openings has a size ranging from 20 μm to 1000 μm.

18. The system of claim 16, further comprising an attrition mill.

19. A method for removing one or more calcium compounds from a lithium-containing claystone, the method comprising:
feeding the lithium-containing claystone into the system of claim 16, wherein the one or more lithium compounds have an average particle size that is smaller than an average particle size of the one or more calcium compounds; and
producing a calcium material-concentrated layer and a lithium material-concentrated layer.

20. The method of claim 19, wherein the lithium-containing claystone further comprises aluminum compounds, iron compounds, potassium compounds, magnesium compounds, sodium compounds, or any combination thereof.

21. The method of claim 19, further comprising adding a chemical dispersant, wherein the chemical dispersant is a sodium polyphosphate, a sodium polyphosphate, a sodium polyphosphate, an oak tannin, a sodium polymethacrylate, or any combination thereof.
